(19) United States
(12) Patent Application Publication
(10) Pub. No.: US 2026/0075653 A1
(43) Pub. Date: Mar. 12, 2026

(54) TECHNIQUES FOR TRIGGERING RANDOM ACCESS PROCEDURES AT PASSIVE DEVICES

(71) Applicant: QUALCOMM Incorporated, San Diego, CA (US)

(72) Inventors: Ahmed ELSHAFIE, San Diego, CA (US); Huilin XU, Temecula, CA (US); Zhikun WU, Beijing (CN); Yuchul KIM, San Diego, CA (US); Wei YANG, San Diego, CA (US); Linhai HE, San Diego, CA (US); Wanshi CHEN, San Diego, CA (US); Peter GAAL, San Diego, CA (US)

(21) Appl. No.: 19/106,162

(22) PCT Filed: Oct. 20, 2022
(86) PCT No.: PCT/CN2022/126357

§ 371 Date: Feb. 24, 2025

(51) Int. Cl. H04W 74/0833; H04W 4/02; H04W 72/0446

(52) U.S. Cl. CPC H04W 74/0833; H04W 4/025; H04W 72/0446

(57) ABSTRACT

Methods, systems, and devices for wireless communication are described. A first network node may transmit control signaling to a second work node, which may indicate a grant of one or more resources and one or more parameters associated with a random access procedure to be performed at one or more passive network nodes that support backscatter communication. The second network node may transmit, in the one or more resources, a signal to activate the one or more passive network nodes. The second node may transmit command information to the one or more passive network nodes that may indicate the one or more parameters for the random access procedure. The first network node may transmit group control signaling to multiple energy harvesting network nodes. In such examples, the group control signaling may indicate a request for the multiple energy harvesting network nodes to perform a random access procedure.

### CROSS REFERENCE

The present Application is a 371 national stage filing of International PCT Application No. PCT/CN2022/126357 by ELSHAFIE et al. entitled “TECHNIQUES FOR TRIGGERING RANDOM ACCESS PROCEDURES AT PASSIVE DEVICES,” filed Oct. 20, 2022, which is assigned to the assignee hereof, and which is expressly incorporated by reference in its entirety herein.

### INTRODUCTION

The following relates to wireless communications relating to techniques for triggering random access procedures at passive devices.

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

### SUMMARY

The described techniques relate to improved methods, systems, devices, and apparatuses that support techniques for triggering random access procedures at passive devices. For example, the described techniques provide a framework for triggering random access procedures using control signaling. In some examples, a first network node may transmit control signaling to a second network node, which may indicate a grant of one or more resources and one or more parameters associated with a random access procedure to be performed at one or more passive network nodes that support backscatter communication. In response to receiving the control signaling, the second network node may transmit a signal to activate the one or more passive network nodes. In some examples, the second node may transmit command information to the one or more passive network nodes that may indicate the one or more parameters for the random access procedure. In some other examples, the first network node may transmit group control signaling to multiple energy harvesting network nodes. In such examples, the group control signaling may indicate a request for the multiple energy harvesting network nodes to perform a random access procedure with the first network node or one or more other network nodes.

A method for wireless communication at a first network node is described. The method may include receiving, from a second network node, control information that indicates a grant of one or more resources and one or more parameters associated with a random access procedure to be performed at one or more passive network nodes that support backscatter communication with the first network node, transmitting, in the one or more resources, a signal to activate the one or more passive network nodes, and transmitting, in the one or more resources, command information to the one or more passive network nodes, the command information indicating the one or more parameters for the random access procedure.

An apparatus for wireless communication at a first network node is described. The apparatus may include a memory, and at least one processor coupled to the memory. The at least one processor may be configured to receive, from a second network node, control information that indicates a grant of one or more resources and one or more parameters associated with a random access procedure to be performed at one or more passive network nodes that support backscatter communication with the first network node, transmit, in the one or more resources, a signal to activate the one or more passive network nodes, and transmit, in the one or more resources, command information to the one or more passive network nodes, the command information indicating the one or more parameters for the random access procedure.

Another apparatus for wireless communication at a first network node is described. The apparatus may include means for receiving, from a second network node, control information that indicates a grant of one or more resources and one or more parameters associated with a random access procedure to be performed at one or more passive network nodes that support backscatter communication with the first network node, means for transmitting, in the one or more resources, a signal to activate the one or more passive network nodes, and means for transmitting, in the one or more resources, command information to the one or more passive network nodes, the command information indicating the one or more parameters for the random access procedure.

A non-transitory computer-readable medium having code for wireless communication stored thereon at a first network node is described. The code for wireless communication stored thereon may, when executed by the first network node, cause the first network node to receive, from a second network node, control information that indicates a grant of one or more resources and one or more parameters associated with a random access procedure to be performed at one or more passive network nodes that support backscatter communication with the first network node, transmit, in the one or more resources, a signal to activate the one or more passive network nodes, and transmit, in the one or more resources, command information to the one or more passive network nodes, the command information indicating the one or more parameters for the random access procedure.

Some examples of the method, apparatuses, and non-transitory computer-readable medium described herein may further include operations, features, means, or instructions for receiving an indication of a zone identifier associated with the one or more passive network nodes and transmitting the signal in a direction that may be based on a geographic location of a zone corresponding to the zone identifier.

Some examples of the method, apparatuses, and non-transitory computer-readable medium described herein may further include operations, features, means, or instructions for receiving an indication of a type of passive network node associated with the one or more passive network nodes and transmitting the signal based on the type of passive network node.

Some examples of the method, apparatuses, and non-transitory computer-readable medium described herein may further include operations, features, means, or instructions for receiving an indication of one or more identifiers, where each identifier may be associated with a respective passive network node of the one or more passive network nodes and transmitting the signal that indicates the one or more identifiers.

In some examples of the method, apparatuses, and non-transitory computer-readable medium described herein, the control information includes an indication of one or more query parameters associated with a query (Q) protocol to be performed at the one or more passive network nodes.

In some examples of the method, apparatuses, and non-transitory computer-readable medium described herein, the command information includes an indication of one or more multi-access protocol parameters to be performed at the one or more passive network nodes.

In some examples of the method, apparatuses, and non-transitory computer-readable medium described herein, the command information includes an indication of a respective time domain resource allocation for each passive network node of the one or more passive network nodes to perform the random access procedure.

In some examples of the method, apparatuses, and non-transitory computer-readable medium described herein, the signal includes a continuous wave signal.

Some examples of the method, apparatuses, and non-transitory computer-readable medium described herein may further include operations, features, means, or instructions for receiving an indication that the random access procedure may be to be performed at the one or more passive network nodes and transmitting the signal based on the indication that the random access procedure may be to be performed at the one or more passive network nodes.

In some examples of the method, apparatuses, and non-transitory computer-readable medium described herein, the control information includes an indication of a radio network temporary identifier (RNTI) that indicates that the control information includes the one or more parameters associated with the random access procedure to be performed at the one or more passive network nodes.

In some examples of the method, apparatuses, and non-transitory computer-readable medium described herein, the control information includes a bit pattern in a frequency domain resource assignment (FDRA) field and the bit pattern indicates that the control information includes the one or more parameters associated with the random access procedure to be performed at the one or more passive network nodes.

In some examples of the method, apparatuses, and non-transitory computer-readable medium described herein, the control information includes one or more bits that indicate that the control information includes the one or more parameters associated with the random access procedure to be performed at the one or more passive network nodes.

Some examples of the method, apparatuses, and non-transitory computer-readable medium described herein may further include operations, features, means, or instructions for receiving, based on the command information, a random access message from at least one passive network node of the one or more passive network nodes.

Some examples of the method, apparatuses, and non-transitory computer-readable medium described herein may further include operations, features, means, or instructions for receiving a physical downlink control channel (PDCCH) order that indicates the grant of one or more resources and the one or more parameters associated with the random access procedure to be performed at the one or more passive network nodes.

A method for wireless communication at a network node is described. The method may include communicating, with a set of multiple energy harvesting network nodes, control information to identify a cycle of active and inactive durations for the set of multiple energy harvesting network nodes that are capable of carrier wave generation and transmitting, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure.

An apparatus for wireless communication at a network node is described. The apparatus may include a memory, and at least one processor coupled to the memory. The at least one processor may be configured to communicate, with a set of multiple energy harvesting network nodes, control information to identify a cycle of active and inactive durations for the set of multiple energy harvesting network nodes that are capable of carrier wave generation and transmit, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure.

Another apparatus for wireless communication at a network node is described. The apparatus may include means for communicating, with a set of multiple energy harvesting network nodes, control information to identify a cycle of active and inactive durations for the set of multiple energy harvesting network nodes that are capable of carrier wave generation and means for transmitting, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure.

A non-transitory computer-readable medium having code for wireless communication stored thereon at a network node is described. The code for wireless communication stored thereon may, when executed by the network node, cause the network node to communicate, with a set of multiple energy harvesting network nodes, control information to identify a cycle of active and inactive durations for the set of multiple energy harvesting network nodes that are capable of carrier wave generation and transmit, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure.

Some examples of the method, apparatuses, and non-transitory computer-readable medium described herein may further include operations, features, means, or instructions for transmitting the group control information using a groupcast mode.

In some examples of the method, apparatuses, and non-transitory computer-readable medium described herein, the group control information includes an indication of a RNTI that indicates the request for the set of multiple energy harvesting network nodes to perform the random access procedure.

In some examples of the method, apparatuses, and non-transitory computer-readable medium described herein, the group control information includes a bit pattern in a FDRA field.

In some examples of the method, apparatuses, and non-transitory computer-readable medium described herein, the group control information includes a random access preamble index that indicates a type of random access procedure to be performed at the set of multiple energy harvesting network nodes.

In some examples of the method, apparatuses, and non-transitory computer-readable medium described herein, the group control information includes one or more bits that indicate the request for the set of multiple energy harvesting network nodes to perform the random access procedure.

Some examples of the method, apparatuses, and non-transitory computer-readable medium described herein may further include operations, features, means, or instructions for receiving, during the active duration and based on the group control information, at least one random access messages from one or more energy harvesting network nodes of the set of multiple energy harvesting network nodes.

Some examples of the method, apparatuses, and non-transitory computer-readable medium described herein may further include operations, features, means, or instructions for transmitting a PDCCH order that indicates the request for the set of multiple energy harvesting network nodes to perform the random access procedure and the resource allocation for the set of multiple energy harvesting network nodes to perform the random access procedure.

### BRIEF DESCRIPTION OF THE DRAWINGS

FIGS. 1 through 4 each illustrate an example of a wireless communication system that supports techniques for triggering random access procedures at passive devices in accordance with one or more aspects of the present disclosure.

FIGS. 5 and 6 each illustrates an example of a process flow that supports techniques for triggering random access procedures at passive devices in accordance with one or more aspects of the present disclosure.

FIGS. 7 and 8 show block diagrams of devices that support techniques for triggering random access procedures at passive devices in accordance with one or more aspects of the present disclosure.

FIG. 9 shows a block diagram of a communications manager that supports techniques for triggering random access procedures at passive devices in accordance with one or more aspects of the present disclosure.

FIG. 10 shows a diagram of a system including a device that supports techniques for triggering random access procedures at passive devices in accordance with one or more aspects of the present disclosure.

FIGS. 11 and 12 show block diagrams of devices that support techniques for triggering random access procedures at passive devices in accordance with one or more aspects of the present disclosure.

FIG. 13 shows a block diagram of a communications manager that supports techniques for triggering random access procedures at passive devices in accordance with one or more aspects of the present disclosure.

FIG. 14 shows a diagram of a system including a device that supports techniques for triggering random access procedures at passive devices in accordance with one or more aspects of the present disclosure.

FIGS. 15 through 18 show flowcharts illustrating methods that support techniques for triggering random access procedures at passive devices in accordance with one or more aspects of the present disclosure.

### DETAILED DESCRIPTION

Some wireless communication systems may be configured to support devices capable of obtaining energy from external sources. For example, a wireless communication system may support passive (or semi-passive) devices that use external sources for obtaining energy. Additionally, or alternatively, such devices may backscatter signals from an external source to communicate with the external source or one or more other devices. Additionally, or alternatively, the wireless communication system may support active devices that use energy obtained from external sources for data encoding, data decoding, filtering operations, transmitting signals, receiving signals, or perform any combination of these processes or other processes.

In some examples, passive devices and active devices may use a random access procedure to establish a connection with a network and obtain timing information for synchronization. The network, such as one or more network entities, may transmit signaling to a device (e.g., a passive device, an active device) to trigger the device to perform the random access procedure. In some examples, such as to conserve energy, the device may enter a sleep state in which one or more operations at the device may be disabled. In such examples, the device may be incapable of establishing a connection with the network, for example due to the one or more operations being disabled. As such, to establish a connection with the network, the device may enter an active state in which the device may receive (and decode) signaling from the network.

In some examples, such as examples in which the device may be a passive (or semi-passive) device, the device may use signaling from a dedicated energy source (e.g., a network entity or a user equipment (UE)) to transition from the sleep state to the active state. For example, the network entity may transmit signaling to activate the device and to trigger the device to perform a random access procedure. In some examples, however, the network entity may transmit signaling to activate and establish connections with multiple devices (e.g., multiple passive devices), which may lead to increased overhead.

Various aspects of the present disclosure generally relate to techniques for triggering random access procedures, and more specifically, to a framework for triggering random access procedures using control signaling, such as a physical downlink control channel (PDCCH) order. For example, a UE serving as a dedicated energy source for multiple devices (e.g., multiple passive or semi-passive devices) may assist the network entity with triggering one or more of the multiple devices to perform a random access procedure. For example, the UE may receive a control message (e.g., a PDCCH order) that identifies a device to the UE and indicates one or more parameters associated with a random access procedure to be performed at the device. In some examples, such as in response to receiving the PDCCH order, the UE may transmit signaling to activate the device. Additionally, or alternatively, the UE may transmit signaling (e.g., a command message) to indicate, to the device, the one or more parameters associated with the random access procedure. In some examples, the device may use signaling transmitted from the UE to transmit (e.g., using backscattering) a random access message as part of the random access procedure. The device may transmit the random access message to the network entity, the UE, or one or more other devices, such as a dedicated reader. Although a dedicated reader is referred to throughout the disclosure, it should be understood that the techniques described herein may also apply to other devices capable of receiving signaling from or transmitting signaling to passive (or semi-passive) devices and active devices.

In some examples, the network entity may transmit signaling to multiple devices (e.g., multiple active devices) to align an active state of the devices. For example, the network entity may transmit control signaling to the devices to trigger the devices to transition (e.g., during a same duration) from a sleep state to the active state. In such an example, the network entity may transmit group control signaling (e.g., a group PDCCH order) to the devices to trigger the devices to perform a random access procedure.

Particular aspects of the subject matter described herein may be implemented to realize one or more potential advantages. For example, the techniques employed by the described communication devices may provide benefits and enhancements to the operation of the communication devices, including reduced overhead associated with triggering random access procedures at one or more devices (e.g., passive or semi-passive devices, active devices). For example, operations performed by the described communication devices may provide a framework for enabling a UE to assist the network in triggering a random access procedure at one or more passive (or semi-passive) devices. Additionally, or alternatively, operations performed by the described communication devices may provide a framework for enabling a network entity to trigger a random access procedure at multiple active devices using a group control signaling. In some implementations, the operations performed by the described communication devices to assist the network in triggering the random access procedure at one or more passive devices may include transmitting a PDCCH order that identifies a passive devices to the UE and indicates one or more parameters associated with the random access procedure to be performed at the passive device. In some other implementations, the operations performed by the described communication devices to trigger the random access procedure at multiple active devices may include transmitting a group PDCCH order that indicates a request for the multiple active devices to perform the random access procedure. In some other implementations, operations performed by the described communication devices may also support reduced power consumption, increased throughput, and higher data rates, among other benefits.

Aspects of the disclosure are initially described in the context of wireless communication systems and process flows. Aspects of the disclosure are also illustrated by and described with reference to apparatus diagrams, system diagrams, and flowcharts that relate to techniques for triggering random access procedures at passive devices.

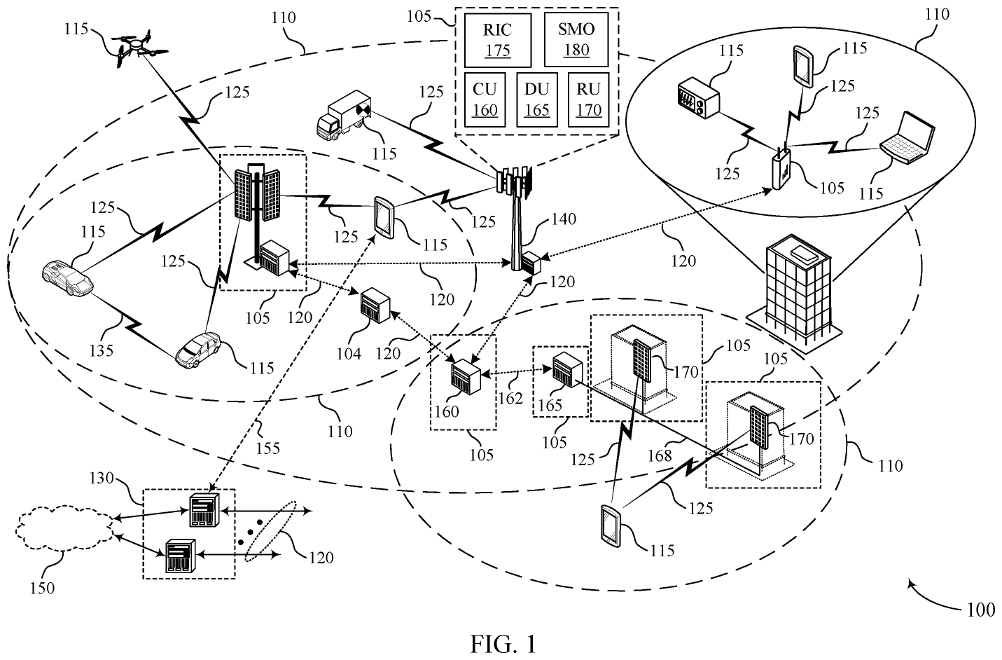

FIG. 1 illustrates an example of a wireless communication system 100 that supports techniques for triggering random access procedures at passive devices in accordance with one or more aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communication systems (e.g., wireless communication system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for triggering random access procedures at passive devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communication resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing.

Each slot may include a quantity of symbol periods (e.g., depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter (dm) to one meter (m) in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communication system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communication system 100 may support a framework for triggering random access procedures using control signaling. For example, a first network node (e.g., a network entity 105) may transmit control signaling to a second network node (e.g., a UE 115), which may indicate a grant of one or more resources and one or more parameters associated with a random access procedure to be performed at one or more passive network nodes (e.g., one or more passive or semi-passive devices) that support backscatter communication. In response to receiving the control signaling, the UE 115 may transmit a signal to activate the one or more passive network nodes. In some examples, the UE 115 may transmit command information to the one or more passive network nodes that may indicate the one or more parameters for the random access procedure. In some other examples, the network entity 105 may transmit group control signaling to multiple energy harvesting network nodes (e.g., active devices). In such examples, the group control signaling may indicate a request for the multiple energy harvesting network nodes to perform a random access procedure with the network entity 105, the UE 115, or another UE 115 (e.g., a dedicated reader). In some examples, using the UE 115 to trigger a random access procedure at one or more passive nodes or using the group control signaling to trigger a random access procedure at multiple energy harvesting nodes may lead to reduced overhead and increased communication reliability within the wireless communication system 100, among other possible benefits.

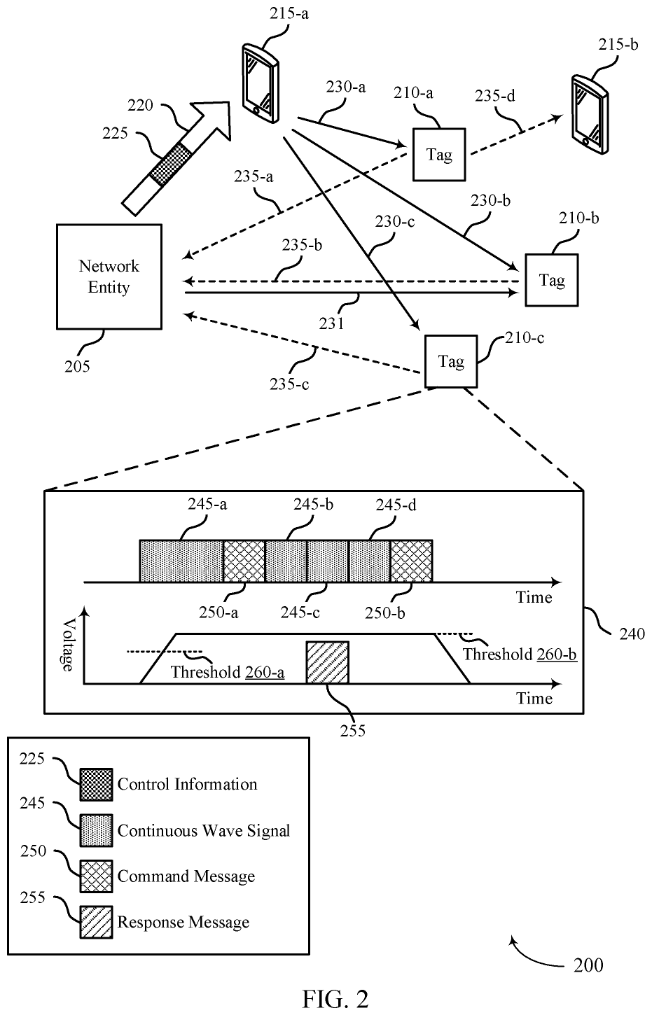

FIG. 2 illustrates an example of a wireless communication system 200 that supports techniques for triggering random access procedures at passive devices in accordance with one or more aspects of the present disclosure. In some examples, the wireless communication system 200 may implement aspects of the wireless communication system 100. For example, the wireless communication system 200 may include a network entity 205, a UE 215-a, and a UE 215-b, which may be examples of the corresponding devices as described with reference to FIG. 1. The wireless communication system 200 may also include a tag 210-a, a tag 210-b, and a tag 210-c, which be examples of a passive (or semi-passive) device or an active device, as described with reference to FIG. 1.

In some examples, the wireless communication system 200 may correspond to a 5G system or another system that supports one or more other RATs. In such examples, the wireless communication system 200 may support energy harvesting enabled communication services (EHECS). For example, the wireless communication system may support one or more tags 210 (e.g., the tag 210-a, the tag 210-b, the tag 210-c), which may be examples of battery-less devices or devices with constrained energy storage (e.g., limited energy storage devices), such as capacitor devices. In some examples, the tags 210 may support radio frequency (or other frequency) power sourcing and may be used (e.g., throughout the wireless communication system 200) for security, access control, connectivity management, and positioning, among other examples.

Additionally or alternatively, the wireless communication system 200 may support passive IoT (e.g., for 5G-Advanced). For example, the tags 210 may be examples of passive IoT devices (e.g., relatively lowest tier devices). For example, the tags 210 may be examples of radio frequency identification (RFID) tags with a power consumption less than about 100 microwatts (μW). In such examples, the tags 210 may support energy harvesting and backscatter communications. Additionally, or alternatively, the tags 210 may support suitable key performance indicators (KPIs), such as data rates, power, densities, and the like. In some examples, the tags 210 may support operations in multiple networks, such as a public land mobile networks (PLMNs) and non-public networks (NPNs), among other examples. For example, multiple networks may support on-boarding, provisioning, and decommissioning of the tags 210. In some examples, a wireless communication network may use the tags 210 for identification, tracking, authentication, authorization, access control, mobility management, security, and one or more constraints for communication.

In some examples of the wireless communication system 200, the tags 210 may correspond to ambient power enabled IoT devices. In such examples, the tags 210 may support multiple types of traffic scenarios and multiple types of device features (e.g., constraints). For example, the wireless communication system 200 may support an industrial wireless sensor network in which the tags 210 may be maintenance-free, battery-less, ultra-low power, and support a relatively long service life. Additionally, or alternatively, the wireless communication system 200 may support smart logistics and smart warehousing in which the tags 210 may be associated with relatively low cost (e.g., extremely-low cost) and a relatively small form factor. Additionally, or alternatively, the tags 210 may be maintenance-free, have increased durability, and have a relatively long lifespan, among other aspects. In some examples, the wireless communication system 200 may support a smart home network in which the tags 210 may be associated with relatively low cost (e.g., ultra-low cost) and a relatively small (e.g., very small) form factor. Additionally, or alternatively, the tags 210 may be washable, relatively flexible, have a relatively foldable form factor, and have a relatively long (e.g., very long) lifespan. In some examples, the wireless communication system 200 may support smart agriculture in which the tags 210 may support operations using energy harvested from solar or other power sources, such as heat.

In various examples of the wireless communication system 200, the tags 210 may be examples of passive devices (e.g., passive nodes, such as type A devices), energy storage intermittent passive devices (e.g., energy storage nodes, such as type B1 devices), semi-passive devices (e.g., semi-passive nodes, such as type B2 devices), active devices, radio frequency-front-end devices (e.g., type C1 devices), normal receiver devices with extended discontinuous reception (eDRX) (e.g., type C2 devices), among other examples. In some examples, a passive device may support radio frequency incident energy harvesting with a power consumption of about 1 μW, a reference sensitivity of about −20 decibel-milliwatts (dBm), and may be on continuously (or discontinuously). For example, a passive device (e.g., a passive tag, such as one of the tags 210) may be powered by radio frequency power, such as by a continuous radio frequency wave. In some examples, the passive device may communicate using backscattered signals (e.g., may be incapable of carrier wave generation or power amplification). Additionally, or alternatively, the passive device may support a link budget of about 75 dB, for example if a dedicated reader transmit power is about 46 dBm. In some examples, a passive device may use a rectifier for radio frequency energy harvesting. In such examples, a power threshold (e.g., about −30 dBm) associated with the rectifier may lead to a bottleneck in the link budget. Additionally, or alternatively, a passive device may be incapable of support frequency division duplex (FDD).

In some examples, an energy storage intermittent passive device may support radio frequency energy harvesting (e.g., from a UE), ambient energy harvesting, an average power consumption of about 1 μW (e.g., with a peak power consumption of about 10 μW to about 20 μW), a relatively low power communication range between about −50 dBm and about −70 dBm, may support intermittent communication, and may include an amplifier, for example for downlink and uplink communications.

In some examples, a semi-passive device (e.g., a semi-passive tag, such as one or more of the tags 210) may support ambient energy harvesting, a button battery, a power consumption of about 100 μW, a relatively low power communication range between about −50 dBm and about −70 dBm, may be on continuously (or discontinuously), and may include an amplifier, such as for downlink and uplink communications. For example, a semi-passive device may be powered by energy harvesting (e.g., solar) and include a power amplifier with power gains of about 20 dB (e.g., for reflected signals). Additionally, or alternatively, a semi-passive device may communicate using backscattered signals. In some examples, a semi-passive device may have a link budget of about 95 dB, for example if a dedicated reader transmit power (e.g., a transmit power associated with a dedicated reader or a dedicated energy source) is about 46 dBm. Additionally, or alternatively, a semi-passive device may have a receive power sensitivity of about −50 dBm and a power associated with signal reflected using a semi-passive device may approach −30 dBm. A semi-passive device may support FDD, for example with a carrier offset of about 10 ppm to about 20 ppm (e.g., for uplink signals). In some examples, power consumption for FDD may be at about a 10 μW level.

In some examples, an active device (e.g., an active tag, an energy harvesting network node, one or more of the tags 210) may support energy harvesting and radio frequency modulation for uplink. For example, an active device may obtain power using (e.g., be powered by) energy harvesting and may be capable of radio frequency carrier wave generation. In some examples, an active device may have a power consumption less than about 500 μW. For example, radio frequency carrier wave generation at an active device may lead to a power consumption of about 100 μW.

Additionally, or alternatively, an active device may transmit signals using a transmit power amplifier, which may lead to a power consumption of about 50 μW (e.g., for an output power of about −20 dBm). In some examples, an active device may have a link budget of about 110 dBm to about 120 dBm, for example if a dedicated reader transmit power is about 46 dBm. In some examples, an uplink transmit power associated with an active device may be decoupled from a downlink received signal power. Additionally, or alternatively, an active device may support FDD. In some examples, an active device may support FDD with a carrier offset of about 10 ppm to about 20 ppm (e.g., for uplink signals).

In some examples, a radio frequency-front-end device may support a suitable power supply for a radio frequency-front-end transceiver, a power consumption of about 1 milliwatts (mW), a same range of power communication as a wide-area network (WAN) (e.g., about 1000 dBm), and a radio frequency-front-end transceiver.

Additionally, or alternatively, a radio frequency-front-end device may be on continuously (or discontinuously) and may include an amplifier, for example for downlink and uplink communications. A normal receiver devices with eDRX may support a suitable power supply, a power consumption of about 1 mW, a same range of power communication as a WAN (e.g., about 1000 dBm), a front-end transceiver (e.g., a full front-end transceiver), and eDRX with relatively low traffic (e.g., extremely low traffic). In some examples, eDRX may be leveraged to achieve relatively low (e.g., extremely low) average power consumption. Leveraging eDRX to achieve relatively low average power consumption may, in some instances, lead to relatively high device costs and relatively high latency.

In some examples, the wireless communication system 200 (e.g., one or more of the tags 210) may support an end-to-end (E2E) architecture design, such as for 5G passive IoT, that may be compatible with some RFID management platforms (e.g., RFID management platforms that may be deployed within the wireless communication system 200 or one or more other wireless communication systems). For example, the wireless communication system 200 may support passive IoT with a core network. In some examples, passive IoT with a core network may support relatively wide areas (e.g., transportation, logistics, seaports), multiple tag protocols (e.g., PHY, MAC, RRC, NAS, and APP protocols), core network mobility management, core network tag authentication, and core network reader authentication. Additionally, or alternatively, passive IoT with a core network may support semi-passive tags, which may lead to relatively high costs with respect to the tags 210 and the network (e.g., the network entity 205). Additionally, or alternatively, the wireless communication system may support passive IoT without a core network. In some examples, passive IoT without a core network may support relatively localized areas and relatively wide areas (e.g., warehouses, factories, logistics), multiple tag protocols e.g., PHY, MAC, RRC, and APP protocols), user application mobility management, user application tag authentication, and user application reader authentication. Additionally, or alternatively, passive IoT without a core network may be compatible with some (e.g., existing or future) RFID management platforms. In some examples, passive IoT without a core network may be more consumer friendly (e.g., relative to passive IoT with a core network) as it may support both passive and semi-passive IoT, which may lead to reduced costs with respect to both the tags 210 and the network (e.g., the network entity 205).

The wireless communication system 200 (e.g., one or more of the tags 210) may support multiple RAN architectures. For example, the wireless communication system 200 may support a 1-1 architecture in which the tags 210 may support a direct connection to the network entity 205 (e.g., a gNB). In such an example, the network entity 205 may serve as an energy supply to the tags 210, may trigger downlink inventory, and may serve as an uplink receiver (e.g., a receiver of uplink backscatter from the tags 210). In some examples, such as examples in which a transmit power at the network entity 205 may be about 46 dBm per 180 kilohertz (kHz), a reference sensitivity (e.g., a reference sensitivity power level associated with the tags 210) may be about −100 dBm per 180 kHz. In some examples of a 1-1 architecture, a propagation delay associated with communications between the tags 210 and the network entity 205 may be relatively low. Additionally, or alternatively, in some examples of a 1-1 architecture, a link budget associated with downlink communications may be about 66 decibels (dB) and an a link budget associated with uplink communications may be about 80 dB. In such examples, coverage may be constrained by downlink communications and relatively dense deployments may be used for relatively wide area deployments.

In some other examples, the wireless communication system 200 may support a 1-2 architecture in which the tags 210 may support a direct connection to the network entity 205 with energy supplied. In some examples of a 1-2 architecture, an energy supply node (e.g., the UE 215-a, the UE 215-b, the network entity 205) may serve as an energy supply to the tags 210. In such examples, a reference sensitivity associated with the tags 210 for energy supply (e.g., from the energy supply node) may be about −20 dBm per 180 kHz. In some examples, an energy supply node may be referred to as a dedicated energy source or a radio frequency source, among other examples. In some examples of a 1-2 architecture, the network entity 205 may trigger downlink inventory and may serve as an uplink receiver (e.g., receiver of uplink backscatter from the tags 210). In such examples, a reference sensitivity associated with the tags 210 for downlink signals (e.g., from the network entity 205) may be about −50 dBm per 180 kHz and a transmit power associated with the tags 210 may be about −20 dBm per 180 kHz. Additionally, or alternatively, in some examples of a 1-2 architecture, a propagation delay associated with communications between the tags 210 and the network entity 205 may be relatively low, a link budget associated with downlink communications may be about 96 dB, and an a link budget associated with uplink communications may be about 80 dB. In such examples, coverage may be constrained by uplink communications. Additionally, or alternatively, in some examples, coverage withing a 1-2 architecture may be increased relative to a 1-1 architecture. In some examples, inclusion of an energy supply node (e.g., a helper) in the RAN architecture may lead to a more consumer friendly design.

In some examples, the tags 210 may be examples of ambient IoT devices (e.g., IoT devices that may obtain power from ambient energy sources). For example, the wireless communication system 200 may be an example of a smart grid that supports ambient IoT (e.g., using the tags 210). In such an example, the tags 210 may be IoT sensors, such as for temperature, humidity, vibration, and pressure. Additionally, or alternatively, the tags 210 may be capable of performing read and write operations and ID requests. For example, the tags 210 may be capable of storing information. In some examples, the tags 210 may include a constrained battery source and may operate using a relatively light weight protocol. In some other examples, the wireless communication system 200 may be an example of a smart home that supports ambient IoT devices (e.g., the tags 210) that may be radio frequency powered. In such an example, the tags 210 may provide position information (e.g., for discovery of personal items at the smart home) through ranging. In some examples, the tags 210 may be used for house asset management. In such an example, the house asset management may be associated with an ambient IoT service latency of about 200 ms, an ambient IoT service availability of about 99.9%, a service bit rate (e.g., user experienced data rate) of about 10 kilobits per second (Kbps) (e.g., for uplink), an uplink message size of about 96 bits, a device density of less than about 500 per m², a communication range of about 10 m, and a service area of about 100 m².

Additionally or alternatively, the tags 210 (e.g., ambient IoT devices) may support multiple traffic scenarios. As a illustrative example, the tags 210 may be (or may be part of) containers at a flower auction. In such an example, the tags 210 may be about 1350 millimeters (mm) long, about 565 mm wide, and about 1900 m high. Additionally, or alternatively, packing of these containers may be relatively close, such that a density of the tags 210 may be about 1.3 million per km2. In some examples, a spacing between network entities serving the tags 210 (e.g., the network entity 205 and one or more other network entities) may be about 50 m by about 50 m (e.g., across a ceiling that may be located vertically above the tags 210). In such examples, the network entity 205 may have a range (e.g., a maximum range) of about 35 m (e.g., from ceiling to tag), and a quantity of tags 210 (e.g., within the 50 m by 50 m area between network entities) may be about 3000. In some examples, the tags 210 may be powered by radio frequency energy (e.g., ambient radio frequency energy). In such an example, sufficient radio frequency energy may be provided on some intervals (e.g., regular or irregular intervals), subsequent to which the tags 210 may respond by communicating an identity of the respective tag to the network (e.g., to one or more of the network entities serving the tags 210). In some examples, such as subsequent to obtaining power from the radio frequency energy (e.g., from the ambient radio frequency energy), the tags 210 may store power for about 100 ms. In such an example, the tags 210 (e.g., all tags 210 within an area) may respond within a same quantity of time (e.g., about 100 ms). In some examples, a respective identity of each of the tags 210 may be provided using a quantity of bits, such as 500 bits.

In some examples, the tags 210 may support backscatter communication. For example, the tags 210 (e.g., the tag 210-a, the tag 210-b, and the tag 210-c) may backscatter signals to communicate with one or more other devices (e.g., the network entity 205, the UE 215-a, or the UE 215-b). As illustrated in the example of FIG. 2, the UE 215-a (e.g., a dedicated energy source) may transmit a signal 230-a to the tag 210-a (e.g., a passive device). The signal 230-a may interact with the tag 210-a, such that at least a portion of the signal 230-a may be redirected (e.g., backscattered, scattered, reflected). In some examples, at least a portion of the signal 230-a backscattered from (e.g., at, off of) the tag 210-a may include backscattered signal 235-a, which may propagate in a direction associated with the network entity 205. Additionally, or alternatively, at least another portion of the signal 230-a backscattered from the tag 210-a may include backscattered signal 235-d, which may propagate in a direction associated with the UE 215-b (e.g., a dedicated reader).

In some examples, the UE 215-a may transmit signaling to multiple tags 210. For example, the UE 215-a may transmit the signal 230-a to the tag 210-a, a signal 230-b to the tag 210-b, and a signal 230-c to the tag 210-c. In some examples, the signals 230 may be associated with UHF. Additionally, or alternatively, the signal 230-a, the signal 230-b, and the signal 230-c may correspond to a same signal or multiple (e.g., different) signals. The signal 230-b may interact with the tag 210-b, such that at least a portion of the signal 230-b may be redirected (e.g., backscattered, scattered, reflected). In some examples, at least a portion of the signal 230-b backscattered from the tag 210-b may include backscattered signal 235-b, which may propagate in a direction associated with the network entity 205. In some other examples, the backscattered signal 235-b may correspond to at least a portion of another signal (e.g., a signal 231) backscattered from the tag 210-b. For example, the network entity 205 may transmit the signal 231 to the tag 210-b. The signal 231 may interact with the tag 210-b, such that at least a portion of the signal 231 may be redirected (e.g., backscattered, scattered, reflected). In some examples, at least a portion of the signal 231 backscattered from the tag 210-b may include backscattered signal 235-b, which may propagate in a direction associated with the network entity 205 (e.g., may be reflected back towards the network entity 205). Additionally, or alternatively, the signal 230-c may interact with the tag 210-c, such that at least a portion of the signal 230-c may be redirected (e.g., backscattered, scattered, reflected). In some examples, at least a portion of the signal 230-c backscattered from the tag 210-c may include backscattered signal 235-c, which may propagate in a direction associated with the network entity 205.

In some examples, the signals 230 and the signal 231 (e.g., forward links) may be modulate or unmodulated (e.g., a continuous wave signal). Additionally, or alternatively, the backscattered signals 235 (e.g., reverse links, backscatter links) may be modulated (or unmodulated). For example, the tags 210 may modulate the backscattered signals 235, such as to convey information (e.g., send data, transmit data) to a receiving device (e.g., the network entity 205). The backscattered signals 235 may, in some examples, have a range of less than about 10 m. In some examples, the tags 210 may operate in a far field region of an electromagnetic field associated with the signals 230. The tags 210 may transmit data (e.g., modulate the backscattered signals 235) by altering (e.g., changing, switching) a reflection coefficient of one or more antennas (e.g., dipole antennas) at the tags 210. For example, the tags 210 may switch a respective reflection coefficient of one or more antennas between relatively high and relatively low states. In some examples, the tags 210 may use an integrated circuit (IC) (e.g., chip, load) for transmitting data, among other processes.

Additionally or alternatively, the tags 210 may include a rectifier (e.g., a power rectifier), forward link demodulator (e.g., one or more components to support forward link demodulation), logic, and memory. The rectifier, forward link demodulator, logic, and memory may be included in the IC. In some examples, the tags 210 (e.g., UHF RFID tags) may use the rectifier to obtain power. The tags 210 may use the rectifier to convert absorbed power (e.g., rectifier input, such as radio frequency energy) into direct current (DC) voltage. The tags 210 may absorb power (e.g., and reflect power) using one or more antennas. In some examples, the rectifier may include a diode and a relatively large capacitor. The rectifier may, in some examples, have an energy conversion efficiency of about 30%. The tags 210 may use the DC voltage to power one or more operations at the tags 210. In some examples, the tags 210 may support envelope detection. For example, the tags 210 may include an envelope detector to obtain a demodulated signal (e.g., a demodulated envelope) from a modulated signal (e.g., a relatively high-frequency amplitude modulated signal). In some examples, the envelop detector may be included in the forward link demodulator.

In some examples, the tags 210 may support amplitude shift keying (ASK) modulation, phase shift keying (PSK) modulation, or a frequency shift keying (FSK) modulation to modulate the backscattered signals 235. In some examples, ASK modulation may occur using multiple states (e.g., state 1 and state 2). For example, state 1 may correspond to a state in which a resistance associated with the IC and an antenna (e.g., used to absorb power) match. That is, state 1 may be associated with a matched load. For example, radiation power (e.g., power of absorbed radiation) may be equal to power absorbed by the IC. In some examples, state 1 may lead to backscatter power. Additionally, or alternatively, state 2 may correspond to a state in which a resistance associated with the IC and the antenna may be mismatched (e.g., an open circuit). In such an example, state 2 may lead to reduced (e.g., no, few) backscatter power. In some examples, ASK modulation may be associated with a modulation efficiency (e.g., practical or idealized radiation power) of about ⅓ (e.g., about a 5 dB loss).

In some examples, the signals 230 transmitted from the UE 215-a (e.g., a dedicated reader, an interrogator) may be unmodulated (e.g., a continuous wave signal) or modulated (e.g., a modulated wave). For example, the UE 215-a may transmit a modulated signal (e.g., commands, packets) to the tags 210 to convey information (e.g., data, such as bits with a value of 1 or 0). Additionally, or alternatively, the tags 210 may transmit a modulated response (e.g., the backscattered signals 235, a modulated wave) to the UE 215-a, for example in response to receiving a command. In some examples, the UE 215-a (e.g., the dedicated reader, the interrogator), may perform an interrogator-talks-first (ITF) procedure with one or more of the tags 210. For example, as illustrated using the timing diagram 240, the UE 215-a may transmit a continuous wave signal 245 to power up the tag 210-c (e.g., turn on the tag 210-c, trigger the tag 210-c to transition from a sleep state to an active state). In some examples, the UE 215-a may transmit the continuous wave signal 245-a for a duration, such as about 400 microseconds (us). Additionally, or alternatively, the UE 215-a may transmit the continuous wave signal 245-a, such that a threshold voltage 260-a (e.g., a turn on voltage) may be satisfied at the tag 210-c. In some examples, the UE 215-a may transmit a command message 250-a (e.g., a modulated signal) to the tag 210-c, for example to convey information and provide power (e.g., power greater than about −20 dBm) to the tag 210-c.

Additionally or alternatively, the UE 215-a may transmit a continuous wave signal 245-b to the tag 210-c to maintain an active (e.g., turned on) state at the tag 210-c. In some examples, a power associated with the continuous wave signal 245-b may be greater than about −20 dBm. The UE 215-a may transmit a continuous wave signal 245-c to the tag 210-c to provide power (e.g., greater than about −20 dBm) to the tag 210-c. Additionally, or alternatively, the UE 215-a may transmit the continuous wave signal 245-c to the tag 210-c, such as to provide a carrier wave for modulation at the tag 210-c. For example, the tag 210-c may use the continuous wave signal 245-c to transmit a command response 255 (e.g., a modulated command, a modulated signal, a backscattered signal). In some examples, the tag 210-c may transmit the command response to the UE 215-a or to another device such as the UE 215-b or the network entity 205. The UE 215-a may transmit the continuous wave signal 245-d to the tag 210-c, for example to maintain an active (e.g., turned on) state at the tag 210-c. In some examples, a power associated with the continuous wave signal 245-d may be greater than about −20 dBm. Additionally, or alternatively, the UE 215-a may transmit a command message 250-b (e.g., a modulated signal) to convey information and provide power (e.g., power greater than about −20 dBm) to the tag 210-c. In some examples, the tag 210-c may transition to a sleep state in response to receiving the command message 250-b. Additionally, or alternatively, the tag 210-c may transition to a sleep state subsequent to receiving the command message 250-b, for example due to a lack of a power at the tag 210-c (e.g., due to a lack of power being provided to the tag 210-c, such as from the UE 215-a, another dedicated energy source, or ambient energy source). For example, the tag 210-c may transition to a sleep state subsequent to receiving the command message 250-b and in response to the tag 210-c failing to satisfy a threshold voltage 260-b (e.g., an IC voltage) at the tag 210-c.

In some examples, the tags 210 (e.g., RFID tags, energy harvesting devices, radio frequency energy harvesting devices) may use ambient or dedicated energy sources (e.g., dedicated radio frequency sources, a laser, light) to obtain energy. In such examples, the tags 210 may use the obtained energy for data reception (or decoding) or data transmission (e.g., encoding and transmission). In some examples, such as to conserve energy, the tags 210 may transition to a sleep state (e.g., go to a very-deep or ultra-deep sleep mode) in which the tags 210 may disable one or more operations (e.g., operations other than a real time clock). In such examples, the tags 210 may be incapable of maintaining (or establishing) a connection with the network (e.g., the network entity 205), for example due to the one or more operations being disabled. In some examples, however, maintaining a connection with the network (e.g., staying in connected mode) may provide one or more benefits (e.g., be of relatively great use to one or more devices within the wireless communication system 200). For example, maintaining a connection with the network may enable the network entity 205 (e.g., a gNB) to trigger a random access procedure (e.g., a random access channel (RACH) procedure) at the tags 210. In some examples, the network (e.g., the network entity 205) may trigger the random access procedure using a PDCCH order. For example, the network may use a PDCCH order (e.g., in 5G NR) to instruct a tag (e.g., the tag 210-a, the tag 210-b, or the tag 210-c) to perform a random access procedure, such that the tag may retrieve timing information (e.g., timing advance (TA) information), from the network entity 205.

In some examples, however, there may be multiple tags 210 and triggering a random access procedure at each tag (e.g., at the tag 210-a, the tag 210-b, and the tag 210-c individually) may lead to increase overhead at the network entity 205. In such examples, the network entity 205 may use a dedicated reader (e.g., the UE 215-a or the UE 215-b, which may be used to read information from the tags 210) to aid the network entity 205 in triggering a random access procedure at the tags 210 (e.g., RACHing the tags 210). In some examples, the dedicated reader may use a continuous wave (e.g., sine wave) signal trigger the random access procedure at the tags 210. Additionally, or alternatively, the tags 210 may start (e.g., begin) to backscatter (e.g., the continuous wave signal) to the network entity 205 (e.g., a gNB) or another device. That is, the tags 210 may backscatter a continuous wave signal transmitted from the UE 215-a to communicate with the network entity 205, the UE 215-a, or the UE 215-b. In some examples, to trigger (e.g., order) the UE 215-a to transmit the continuous wave signal (e.g., to aid in RACHing the tags 210), the network entity 205 may transmit a PDCCH order to the UE 215-a. For example, the network entity 205 may transmit a PDCCH order to the UE 215-a to order such behavior of the UE 215-a.

Additionally or alternatively, the tags 210 may be examples of energy harvesting devices that may refrain from applying backscatter. For example, the tags 210 may apply relatively low (e.g., very low) power active communication. That is, the tags 210 may be examples of lower tier devices (e.g., relative to narrowband-IoT (NB-IOT) devices) that may rely on energy harvesting, such as solar powered chips. In such an example, the network entity 205 may transmit the PDCCH order to multiple tags (e.g., a group of UEs, a group of tags, a group of energy harvesting devices), which may lead to reduced signaling overhead. In some examples, the tags 210 (e.g., energy harvesting devices) may operate in a sleep mode and an active mode according to a DRX cycle. For example, the tags 210 may perform energy harvesting for a duration (e.g., about 10 minutes) and, subsequently, wake up for a duration (e.g., about a few seconds). In some examples, the tags 210 may operate according to a same DRX cycle. Additionally, or alternatively, the tags 210 may perform a same type of sensing operation, metering operation, or data collecting (e.g., information collecting) operation. For example, the tags may collect (or be asked to collect) a same type of data. In some examples, the tags 210 may be associated with a same tier, type, or class of device (e.g., tag). Additionally, or alternatively, the tags 210 may be located in a same zone or be served by a same UE (e.g., the UE 215-a) or set of UEs (e.g., may be served by same set of radio frequency sources or readers).

In some examples, the tags 210 may be triggered to (or the UE 215-a could be triggered to help them to) perform a random access procedure (e.g., be RACHed together) in a contention-based way or contention-free way. For example, triggering the tags 210 to perform a random access procedure may provide for aligned data collection at the tags 210. Additionally, or alternatively, triggering the tags 210 to perform a random access procedure may lead to reduced DCI monitoring at the tags 210 and conserve power at the PDCCH order transmitting devices (e.g., the network entity 205). For example, a UE (e.g., the UE 215-a) may be configured with up to 3 (or up to 5 or some other suitable quantity) control resource sets (CORESETs) in a BWP of a serving cell (e.g., a component carrier (CC)). In such an example, each CORESET may be associated with an active TCI state. Additionally, or alternatively, as part of one or more CORESET configurations, a quantity of resource blocks (RBs) of a CORESET (e.g., of the configured CORESETs) in a frequency domain and a quantity of symbols of a CORESET (e.g., 1, 2, or 3 OFDM symbols) may be RRC configured. In some examples, each search space set may be associated with one CORESET (e.g., of the configured CORESETs). For example, the network may configure up to about 10 search space sets in a BWP of the CC.

In some examples, as part of one or more search space set configurations, the network may configure (e.g., RRC configure) one or more parameters. The one or more parameters may include an associated CORESET, a monitoring slot periodicity and offset, one or more monitoring symbols within a slot (e.g., which may determine PDCCH monitoring occasions of the respective search space set), a search space set type (e.g., common search space (CSS) or UE-specific search space (USS)), DCI formats to monitor, and a quantity of PDCCH candidates for a given aggregation level (AL). In some examples, PDCCH candidates may be defined as part of search space set configurations. For example, a PDCCH candidate with an AL and a PDCCH candidate index may be defined in (e.g., may be associated with) a search space set. In some examples, a DCI may be received in a PDCCH candidate. For example, the UE 215-a may monitors one or more PDCCH candidates in a search space sets, and one or more candidates with a cyclic redundancy check (CRC) pass (e.g., with successful decoding) my correspond to a decoded DCI. That is, the UE 215-a may blindly decode DCI within PDCCH candidates.

In some examples, a DCI (e.g., a PDCCH order) may be used to request a random access procedure (e.g., at the UE 215-a or the tags 210). For example, the network entity 205 may transmit a PDCCH order using a DCI format (e.g., a DCI format 1_0 with a cell radio network temporary identifier (C-RNTI)). In some examples, the DCI may include one or more fields. For example, the DCI may include a frequency domain resource assignment (FDRA) field. In such an example, the UE 215-a (or the tags 210) may determine whether the DCI corresponds to a PDCCH order based on a value of a quantity of bits associated with the FDRA field. For example, if the bits associated with the FDRA field are set to a value of 1, the UE 215-a (or the tags 210) may determine that the DCI corresponds to a PDCCH order. The DCI may also include a random access preamble index field. In such an example, a quantity of bits (e.g., about 6 bits) associated with the random access preamble index field may indicate a random access preamble for the random access procedure. For example, one or more bits associated with the random access preamble index field may be set to 0. In such an example, the UE 215-a (or the tags 210) may be triggered to perform a contention-based random access procedure. In such an example, one or more other fields included in the DCI may be ignored.

In some other examples, one or more bits associated with the random access preamble index field may be set to 1. In such examples, the UE 215-a (or the tags 210) may be triggered to perform a contention-free random access procedure. In such an example, one or more other fields included in the DCI may be used to determine (e.g., indicate) parameters associated with the contention-free random access procedure. For example, the DCI may include an uplink or supplementary uplink (UL/SUL) indicator field. In some examples, one or more bits (e.g., 1 bit) associated with the UL/SUL field may indicate whether supplementary uplink may be configured in a cell associated with the network entity 205. Additionally, or alternatively, a synchronization signal block (SSB) index field. In some examples, one or more bits (e.g., 6 bits) associated with the SSB index field may indicate a synchronization signal or physical broadcast channel (SS/PBCH) that may be used (e.g., at the tags 210) to determine a RACH occasion for a physical random access channel (PRACH) transmission (e.g., transmission of a RACH preamble). In some examples, the DCI may include a PRACH mask index field. In such examples, one or more bits (e.g., 4 bits) associated with the PRACH mask index may indicate a RACH occasion associated with the SS/PBCH indicated using the SS/PBCH field. Additionally, or alternatively, the DCI may include one or more other bits that may be reserved.

In some examples, the UE 215-a (or the tags 210) may transmit the PRACH (e.g., the RACH preamble) using the indicated RACH occasion (e.g., for contention-free random access) or in another RACH occasion that may be associated with a measured SSB (e.g., for contention-based random access). In some examples, subsequent to the PRACH transmission, the UE 215-a (or the tags 210) may monitor one or more PDCCH candidates for a DCI (e.g., a DCI format 1_0 with CRC bits that may be scrambled with a random access RNTI (RA-RNTI)). In such examples, the PDCCH (e.g., the DCI) may schedule a random access response (e.g., to be transmitted from the network entity 205 using a physical downlink shared channel (PDSCH)). In some examples, if the UE 215-a (or the tags 210) performs a contention-free random access procedure using a primary cell (or a primary secondary cell), the UE 215-a (or the tags 210) may assume that the PDCCH with the RA-RNTI may be quasi co-located with the PDCCH order. Additionally, or alternatively, the UE 215-a (or the tags 210) may assumes that the random access response PDSCH may be quasi co-located with the PDCCH order.

In some examples, the network (e.g., the network entity 205) may leverage the PDCCH order (e.g., a control message) to indicate for the UE 215-a to assist in triggering the tags 210 to perform a random access procedure. Additionally, or alternatively, the network entity 205 may transmit another control message (e.g., another DCI) to indicate for the UE 215-a to assist in triggering the tags 210 to perform a random access procedure. In some examples, the network entity 205 may transmit a group control message (e.g., a group PDCCH order or another group DCI) to the tags 210 to trigger a random access procedure at the tags 210. As illustrated in the example of FIG. 2, the network entity may use a communication link 220 (e.g., a Uu link) to transmit control information 225 (e.g., a DCI, a PDCCH order) to the UE 215-a. The control information 225 may indicate a grant of one or more resources and one or more parameters associated with a random access procedure to be performed at one or more of the tags 210. In response to receiving the control information 225, the UE 215-a may transmit the signal 230-a, the signal 230-b, and the signal 230-c to activate the tag 210-a, the tag 210-b, and the tag 210-c, respectively. In some examples, the UE 215-a may determine to activate the tag 210-a, the tag 210-b, and the tag 210-c based on respective identifiers associated with the tags 210 being included in the control information 225. In some examples, the UE 215-a may transmit command information (e.g., a command message 250) to the tags 210 that may indicate the one or more parameters for the random access procedure (e.g., one or more parameters associated with a contention-based random access procedure or a contention-free random access procedure to be performed at the tags 210). In some examples, using the UE 215-a to trigger the random access procedure at the tags 210 may lead to reduced overhead and increased communication reliability within the wireless communication system 200, among other possible benefits.

Additionally, or alternatively, the network entity 205 transmit control information to the tags 210 (e.g., energy harvesting devices) identify a cycle of active and inactive durations (e.g., a DRX cycle) for the tags 210. In some examples, the network entity 205 may transmit group control signaling (e.g., a group PDCCH order, such as using a groupcast mode) to the tags 210 during an active duration (e.g., an active state). The group PDCCH may indicate a request for the tags 210 to perform a random access procedure. Additionally, or alternatively, the group PDCCH order may indicate a resource allocation for the tags 210 to perform the random access procedure. In some examples, transmitting the group PDCCH order to trigger the random access procedure at the tags 210 may lead to reduced overhead and increased communication reliability within the wireless communication system 200, among other possible benefits.

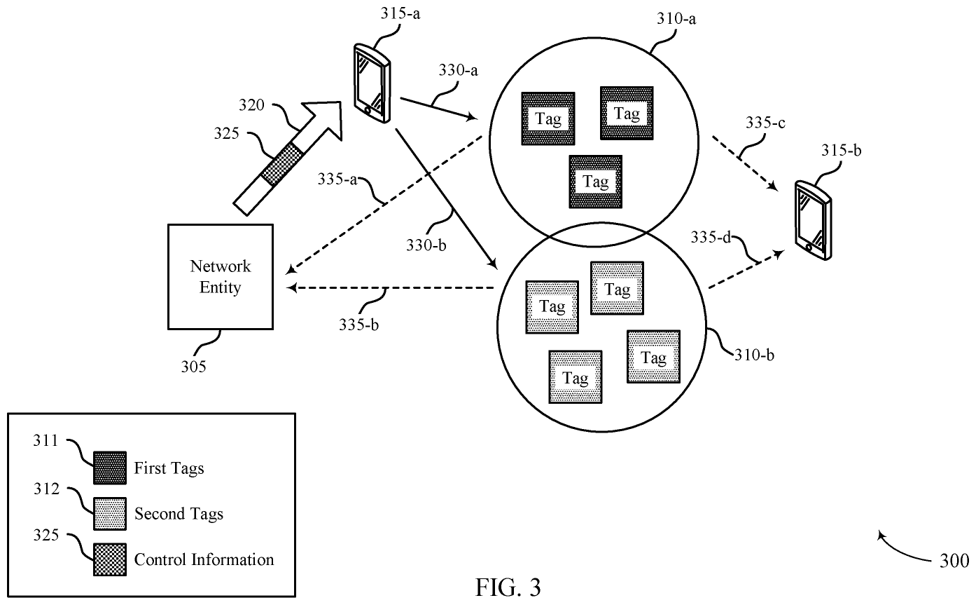

FIG. 3 illustrates an example of a wireless communication system 300 that supports techniques for triggering random access procedures at passive devices in accordance with one or more aspects of the present disclosure. In some examples, the wireless communication system 300 may implement aspects of the wireless communication system 100 and the wireless communication system 200. For example, the wireless communication system 300 may include a network entity 305, a UE 315-a, and a UE 315-b, which may be examples of the corresponding devices as described with reference to FIGS. 1 and 2. The wireless communication system 300 may also include first tags 311 and second tags 312, which be examples the corresponding devices, as described with reference to FIG. 2.

In some examples, the wireless communication system 300 may support a framework for triggering random access procedures using control signaling. The control signaling may include DCI, which may correspond to a PDCCH order in some examples. For example, the network entity 305 (e.g., a gNB or another network unit) may use a type of PDCCH order to order the UE 315-a to assist in RACHing one or more tags. That is, the network entity 305 may use a type of PDCCH order to request the UE 315-a to assist the network entity 305 in triggering random access procedures at one or more of the first tags 311 or the second tags 312. In such an example, the UE 315-a may correspond to (e.g., may serve as) a radio frequency source dedicated for transmitting radio frequency signal to the first tags 311 and the second tags 312, such as a radio frequency UE reader. For example, the network entity 305 may use the UE 315-a to assist the network entity 305 in triggering random access procedures at the first tags 311 or the second tags 312, which may correspond to respective sets of tags, respective groups of tags, or a respective types of tag. That is, the first tags 311 and the second tags 312 may correspond to sets of RFID tags, passive IoT device, active IoT devices, or energy harvesting devices, among other examples. In some examples of the wireless communication system 300, the first tags 311 or the second tags 312 may be examples of energy harvesting devices that may have a common DRX cycle. For example, the first tags 311 or the second tags 312 may perform energy harvesting for a duration (e.g., about 10 min) and wake up for a duration (e.g., about a few seconds). Additionally, or alternatively, the first tags 311 or the second tags 312 may perform a same type of sensing operation, a same type of metering operation, or a same type of data (or other information) collecting operation. In some examples, the first tags 311 or the second tags 312 may be located relatively closely (e.g., in a same zone) or may be served by same radio frequency source or reader. For example, the first tags 311 may be located in a zone 310-a and the second tags 312 may be located in a zone 310-b. Additionally, or alternatively, the first tags 311 and the second tags 312 may be served by the UE 315-a.

The network entity 305 may transmit control information 325 to the UE 315-a, for example using a communication link 320. In some examples, the communication link 320 may be an example of a communication link 125 as described with reference to FIG. 1. The control information 325 may include DCI, which may correspond to a PDCCH order in some examples. In some examples, such as in response to (e.g., upon) receiving the control information 325, the UE 315-a (e.g., a radio frequency source) may transmit a continuous wave signal on a frequency to trigger a random access procedure at a set of tags. That is, the UE 315-a may use a frequency to transmit the continuous wave signal to trigger the random access procedure at a set of RFID tags that may be configured to operate at the frequency, such as the first tags 311 or the second tags 312. For example, the first tags 311 may operate using a first frequency. In such an example, to trigger a random access procedure at the first tags 311, the UE 315-a may transmit a signal 330-a (e.g., a continuous wave signal) using the first frequency. Additionally, or alternatively, the second tags 312 may operate using a second frequency. As such, to trigger a random access procedure at the second tags 312, the UE 315-a may transmit a signal 330-b using the second frequency. For example, the UE 315-a may transmit a radio frequency continuous wave signal (or modulated signal) starting with RFID tags powering up, indicating RFID tag identifiers, and indicating RACH timing to be used for backscatter signaling performed at the tags. That is, the UE 315-a may transmit a radio frequency continuous wave signal (or modulated signal) for powering up the first tags 311 or the second tags 312, indicating respective identifiers associated with the first tags 311 or the second tags 312, and indicating respective timing associated with the random access procedure. The indicated timing may be used at the first tags 311 or the second tags 312 for backscatter signaling performed at the tags as part of the random access procedure.

For example, the signal 330-a may interact with the first tags 311, such that at least a portion of the signal 330-a may be redirected (e.g., backscattered, scattered, reflected). In some examples, at least a portion of the signal 330-a backscattered from (e.g., at, off of) the first tags 311 may include backscattered signal 335-a, which may propagate in a direction associated with the network entity 305. Additionally, or alternatively, at least another portion of the signal 330-a backscattered from the first tags 311 may include backscattered signal 335-c, which may propagate in a direction associated with the UE 315-b (e.g., a dedicated reader). The signal 330-b may interact with the second tags 312, such that at least a portion of the signal 330-b may be redirected (e.g., backscattered, scattered, reflected). In some examples, at least a portion of the signal 330-b backscattered from (e.g., at, off of) the second tags 312 may include backscattered signal 335-b, which may propagate in a direction associated with the network entity 305. Additionally, or alternatively, at least another portion of the signal 330-b backscattered from the second tags 312 may include backscattered signal 335-d, which may propagate in a direction associated with the UE 315-b (e.g., a dedicated reader).

In some examples, the network entity 305 may transmit the control information 325 to the UE 315-a requesting that the UE 315-a assist the network entity 305 in RACHing RFID tags or energy harvesting devices. For example, the network entity 305 may transmit the control information 325 to the UE 315-a requesting that the UE 315-a assist the network entity 305 in triggering a random access procedure at the first tags 311 or the second tags 312. That is, the network entity 305 may indicate a RACH request using the control information 325, which may correspond to a PDCCH order or another DCI unassociated with a PDCCH order. In response, the UE 315-a may transmit a continuous wave signal (e.g., a signal 330-a or a signal 330-b) on dedicated resources indicated to the UE 315-a using the control information 325. In some examples, the network entity 305 may indicate (e.g., define) sidelink-specific or UE to UE link-specific messages for indicating a RACH ordering. For example, the network entity 305 or the UE 315-a may indicate an order associated with performing the random access procedure to the first tags 311 or the second tags 312.

In some examples, the control information 325 may correspond to a PDCCH order modified from another (e.g., existing) PDCCH order. For example, the network entity 305 may exploit a PDCCH design (e.g., an existing PDCCH design) to indicate one or more energy harvesting tags or RFID tags that may be related to a RACH to the UE 315-a. Additionally, or alternatively, the network entity 305 may exploit the PDCCH design to indicate whether a PDCCH order may be for the UE 315-a itself or for the UE 315-a to assist the network entity 305 in triggering the random access procedure at the indicated tags. That is, the network entity 305 may exploit a PDCCH design to indicate, to the UE 315-a, one or more of the first tags 311 or the second tags 312 that may be associated with a random access procedure and whether the UE 315-a may trigger the random access procedure at the UE 315-a or at the one or more of the first tags 311 or the second tags 312.

For example, the network entity 305 may append (e.g., add) details for the indicated tags (e.g., the first tags 311, the second tags 312, the RFID tags, the energy harvesting devices) to the PDCCH order. For example, the network entity 305 may transmit the PDCCH order in which the FDRA pattern may include “1s” and “0s” (e.g., may be different from all “1s”). That is, the PDCCH order may include a bit pattern in the FDRA field, which may include some bits set to a value of 1 and some bits set to a value other than 1. In some examples, the bit pattern may indicate that the PDCCH order includes one or more parameters associated with the random access procedure to be performed at the indicated tags (e.g., the first tags 311 or the second tags 312). Additionally, the PDCCH order may include an RNTI that may indicate that the PDCCH order includes one or more parameters associated with the random access procedure to be performed at the indicated tags. In some examples, the PDCCH order may include one or more reserved bits that may indicate whether the PDCCH order may be for the UE 315-a itself (e.g., whether the PDCCH order may be a modified PDCCH order) or may be for the UE 315-a to assist the network entity 305 in triggering the random access procedure at the indicated tags (e.g., whether the PDCCH order may be an existing PDCCH order). That is, the PDCCH order may include one or more reserved bits that indicate that the PDCCH order includes one or more parameters associated with the random access procedure to be performed at the indicated tags.

Additionally or alternatively, some reserved bits included in the PDCCH order may be used to indicate one or more parameters associated with the random access procedure, for example if the FDRA pattern or the RNTI are used (e.g., included in the PDCCH order). In such an example, the UE 315-a may consider (e.g., check) the reserved bits payload, which may have information for the random access procedure to be performed at the indicated tags. For example, the reserved bits may indicate one or more parameters associated with the random access procedure to be performed at the first tags 311 or the second tags 312, which may be examples of RFID tags or energy harvesting devices. For example, the PDCCH order may include any combination of the FDRA pattern, an RNTI, and one or more reserved bits to indicate, to the UE 315-a, one or more tags associated with a random access procedure and to indicate whether the PDCCH order may be for the UE 315-a itself or for the UE 315-a to assist the network entity 305 in triggering the random access procedure at the indicated tags.

In some examples, the wireless communication system 300 may support a PDCCH order design for a UE assisting the network (e.g., for a helping UE). For example, the network entity 305 may transmit a PDCCH order to the UE 315-a and request a random access procedure at one or more tags (e.g., the first tags 311 or the second tags 312). In some examples, the network entity 305 may transmit the PDCCH order using a DCI format (e.g., DCI format 1_0) with an RNTI (e.g., a C-RNTI). For example, the network entity 305 may use an RNTI for reading from tags (e.g., that is not for self-RACH). That is, the RNTI may include information to be read (e.g., and used) at the one or more tags in which the network entity 305 may be requesting perform a random access procedure, such as the first tags 311 or the second tags 312. In some examples, the UE 315-a may determine whether the control information 325 corresponds to a PDCCH order or another type of DCI based on bits associated with an FDRA field being set to a value of 1. For example, the UE 315-a may determine that the control information 325 corresponds to a PDCCH order if an FDRA field of the DCI is set to all “1”'s. In such examples, the network entity 305 may use another FDRA pattern to indicate that the PDCCH order may be for helping the first tags 311 or the second tags 312 (e.g., may not be for the UE itself). That is, the FDRA pattern may indicate that one or more parameters included in the control information 325 may be associated with a random access procedure to be performed at tags that may be indicated using the PDCCH order, such as the first tags 311 or the second tags 312. In such an example, the PDCCH order may indicate the one or more parameters to the UE 315-a, which the UE 315-a may indicate to the indicated tags. For example, the UE 315-a may convey the one or more parameters to the indicated tags, such that the indicated tags may be triggered to perform the random access procedure in accordance with the parameters indicated from the network entity 305.

In some examples, the control information 325 may include one or more bits (e.g., 6 bits) that correspond to a random access preamble index field. In some examples, if the indicated random access preamble index is 0, the indicated tags may be triggered to perform a contention-based random access procedure. For example, the first tags 311 or the second tags 312 may perform a contention-based random access procedure in response to receiving control information from the UE 315-a that indicates that the random access preamble index is 0. In such examples, the indicated tags (e.g., and the UE 315-a) may ignore some other fields included in the control information 325.

Additionally, or alternatively, the one or more bits associated with the random access preamble index field may indicate, to the UE 315-a, to transmit a continuous wave signal during one or more RACH occasions that may be used for the contention-based random access procedure (e.g., at the indicated tags). In some examples, the one or more bits associated with the random access preamble index field may be used to indicate (e.g., as an explicit indication), to the UE 315-a, to use a query (Q) protocol. For example, if the control information 325 (e.g., the PDCCH order) indicates for the UE 315-a to communicate with multiple RFID tags, such as the first tags 311 or the second tags 312, the network may indicate, to the UE 315-a, to use a Q protocol. The Q protocol may enable the UE 315-a to communicate with the indicated tags one by one in a time domain. In some examples, as part of the Q protocol, a tag may randomly generate a value. The randomly generated value may determine (e.g., identify) a time domain resource (e.g., a slot) which the respective tag may use to respond to the UE 315-a (e.g., a dedicated reader). In some examples of a Q protocol, a Query or QueryRep command may be used to denote a start of the time domain resource (e.g., slot). In some examples, some tags may have a response to transmit in the slot. In such an example, the slot may be relatively long (e.g., longer), otherwise (e.g., if no tag response) the slot may be relatively short (e.g., shorter). Additionally, or alternatively, the slot duration may be determined at the UE 315-a (e.g., the reader). In some examples, using a Q protocol may reduce collisions, for example between responses transmitted from multiple tags. In some examples, the random access preamble index may indicate for the Q protocol to be used with some (e.g., dedicated) resources for the indicated tags (e.g., RFID tags) and with a default value of Q or a value of Q that may be provided in another filed (e.g., included in the control information 325). In some other examples, the one or more bits associated with the random access preamble index field may trigger a contention-free random access procedure at the tags.

In some examples, the network entity 305 may indicate, to the UE 315-a (e.g., the UE helping the RFID tags), one or more respective resources for each indicated tag. For example, the network entity 305 may indicate one or more resourceless for each of the first tags 311 or each of the second tags 312, which may be examples of RFID tags or energy harvesting devices. Additionally, or alternatively, the control information 325 may include one or more bits associated with an UL/SUL indicator field (e.g., an indication of whether supplementary uplink may be configured for a cell associated with the network entity 305), one or more bits (e.g., 6 bits) associated with an SSB index field, one or more bits (e.g., 4 bits) associated with a PRACH mask index field, and one or more reserved bits. In some examples, the reserved bits may be used to indicate whether the associated random access procedure (e.g., the random access procedure associated with the indicated parameters) may be for the UE 315-a itself or for the indicate tags. Additionally, or alternatively, the reserved bits may be used to indicate the tags or a class of tags or a zone associated with tags.

For example, the reserved bits may indicate the first tags 311 or the zone 310-a associated with the first tags 311. In some examples, the reserved bits may be used to indicate a time domain or frequency domain allocation for each duration (e.g., time) within a relatively larger resource provided to the UE 315-a for assisting the indicated tags, which may correspond to energy harvesting devices.

Additionally, or alternatively, the reserved bits may be used to indicate one or more multi-access scheme parameters that may be used by each of the indicated tags. For example, the reserved bits may indicate one or more parameters associated with a multi-access protocol to be performed at each of the first tags 311 or each of the second tags 312. The first tags 311 and the second tags 312 may each correspond to a respective group of RFID tags or respective class of tag. For example, the reserved bits may indicate the respective Q value associated with a tag or parameters for ALOHA scheme. Additionally, or alternatively, the reserved bits may indicate a respective duration (e.g., a time, such as one or more time domain resources) during which a tag may transmit a random access message (e.g., a random access preamble, a PRACH). In some examples, the respective duration may correspond to an indicated RACH occasion (e.g., for contention-free random access) or a RACH occasion associated with a measured SSB (e.g., for contention-based random access). In some examples, subsequent to the PRACH transmission, the indicated tags may monitor for PDCCH with CRC scrambled with RA-RNTI (e.g., a DCI format 1_0), which may schedule a random access response PDSCH. In some examples, the UE 315-a may use a combination of the RNTI, the FDRA pattern, the random access preamble, and the reserved bits to indicate the one or more parameters associated with the random access procedure to the indicated tags.

In some examples, the control information 325 may correspond to a DCI (e.g., a PDCCH DCI) that may indicate a zone identifier (e.g., correspond to a zone associated with the tags, such as the zone 310-a or the zone 310-b). In such an example, the UE 315-a may adjust a beam for the radio frequency source (e.g., a beam generated at the UE 315-a to transmit the command message in a direction associated with the indicated zone). In some examples, the DCI may indicate a tag class, a tag type, or one or more tags associated with a type of data or a priority of data to be read (e.g., at the network entity 305 or a dedicated reader, such as the UE 315-b). In such an example, the indicated type of data or the indicated priority of data may be associated with a tag class or one or more tag identifiers. In some examples, the DCI may indicate one or more respective tag identifiers associated with one or more tags to activate (e.g., wake up). In such examples, the UE 315-a may be configured to determine which tags correspond to the indicated tag identifiers.

Additionally, or alternatively, the DCI may indicate one or more multi-access parameters. For example, the DCI may indicate Q parameters for the Q protocol. In some examples, the DCI may indicate Q parameters if the DCI may be used to read (e.g., receive responses) from multiple tags. Additionally, or alternatively, the DCI may indicate one or more parameters for an ALOHA scheme or one or more other parameters associated with one or more multi-access protocols. In some examples, the DCI may indicate a respective duration (e.g., a time, such as one or more time domain resources) during which a tag may transmit a random access message and whether the tags may use TDM, FDM, or spatial division multiplex (SDM). In some examples, using the UE 315-a to trigger the random access procedure at the first tags 311 or the second tags 312 may lead to reduced overhead and increased communication reliability within the wireless communication system 300, among other possible benefits.

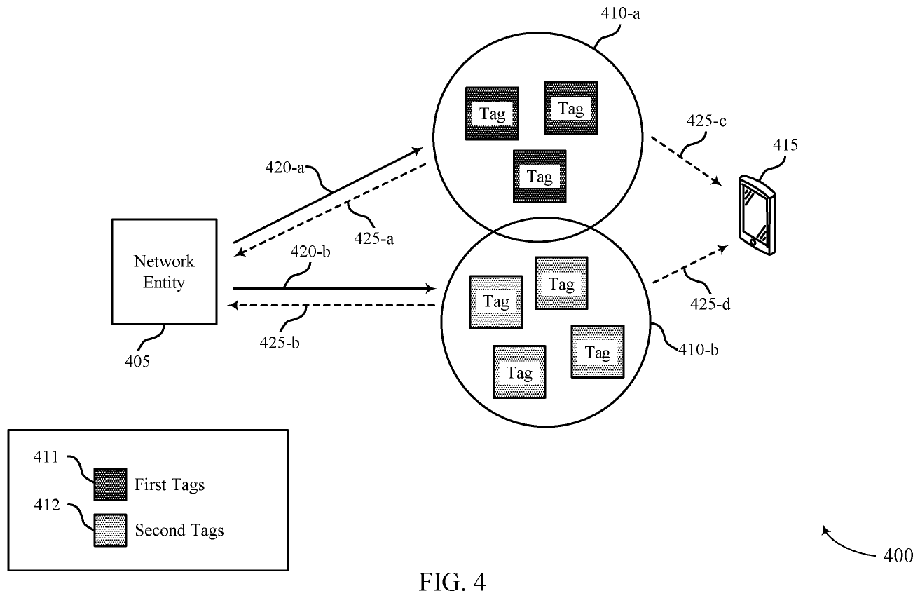

FIG. 4 illustrates an example of a wireless communication system 400 that supports techniques for triggering random access procedures at passive devices in accordance with one or more aspects of the present disclosure. In some examples, the wireless communication system 400 may implement aspects of the wireless communication system 100, the wireless communication system 200, and the wireless communication system 300. For example, the wireless communication system 400 may include a network entity 405 and a UE 415, which may be examples of the corresponding devices as described with reference to FIGS. 1-3. The wireless communication system 400 may also include first tags 411 and second tags 412, which be examples of the corresponding devices, as described with reference to FIGS. 2 and 3.

In some examples, the wireless communication system 400 may support a framework for triggering random access procedures using group control signaling. The control signaling may include DCI, which may correspond to a group PDCCH order in some examples. For example, the network entity 405 may use (e.g., define) a type of PDCCH order, which may be used at the network entity 405 (e.g., a gNB or another network unit) to trigger a random access procedure at multiple tags (e.g., the first tags 411 or the second tags 412). For example, the network entity 405 may use the type of PDCCH order request that the first tags 411 or the second tags 412 perform a random access procedure.

As illustrated in the example of FIG. 4, the network entity 405 may indicate the group PDCCH order to the first tags 411 using signaling 420-a and to the second tags 412 using signaling 420-b. In some examples, the group PDCCH order may indicate for the first tags 411 or the second tags 412 to perform the random access procedure with the network entity 405 or with the UE 415, which may be an example of a dedicated reader. For example, in response to receiving the group PDCCH order, the first tags 411 may transmit a random access message to the network entity 405 using signaling 425-a or to the UE 415 using signaling 425-c. Additionally, or alternatively, in response to receiving the group PDCCH order, the second tags 412 may transmit a random access message to the network entity 405 using signaling 425-b or to the UE 415 using signaling 425-d.

In some examples of the wireless communication system 400, the first tags 411 and the second tags 412 may be examples of energy harvesting devices (e.g., active devices, semi-active devices). For example, the first tags 411 and the second tags 412 may be configured (or preconfigured) with respective DRX cycles (e.g., fixed and predefined durations). In some examples, the first tags 411 and the second tags 412 may each be configured with multiple DRX cycles, such as two configured DRX cycles. For example, the first tags 411 and the second tags 412 may each be configured with an outer DRX cycle (e.g., a respective outer DRX cycle) that may enable the first tags 411 and the second tags 412 to harvest energy (e.g., a suitable quantity of energy) for performing communications. In some examples, the outer DRX cycle may include active durations that may correspond to an active state associated with the respective tag and inactive durations that may correspond to an inactive state associated with the respective tag. For example, the outer DRX cycle may include an outer DRX “ON” duration (e.g., about 1 second, which may be denoted as T2_outer) and an outer DRX cycle duration (e.g., a periodicity associated with the DRX “ON” duration that may be about 10 minutes and denoted as T1_outer).

Additionally, or alternatively, the first tags 411 and the second tags 412 may each be configured with an inner DRX cycle that may be associated with a power efficient duty cycled operation that may enable the first tags 411 and the second tags 412 to be available for scheduling. In some examples, the inner DRX cycle may include active durations that may correspond to an active state associated with the respective tag and inactive durations that may correspond to an inactive state associated with the respective tag. For example, the inner DRX cycle may include an outer DRX “ON” duration (e.g., about 8 ms), which may be denoted as T2_inner) and an inner DRX cycle duration (e.g., a periodicity associated with the DRX “ON” duration that may be about 10 ms and denoted as T1_inner). Some DRX parameters, such as T1_outer, T1_inner, T2_outer, and T2_inner may be based on a charging rate (e.g., associated with the first tags 411 and the second tags 412) and one or more data constraints (e.g., a quantity of PDSCH or PUSCH communications).

In some examples, subsequent to activity (e.g., communications) being complete, the first tags 411 or the second tags 412 may transition (e.g., go directly to) an ultra-low-power state (ULPS) mode. Additionally, or alternatively, energy harvesting devices capable of performing metering or sensing operations (e.g., the first tags 411 and the second tags 412) may be aligned to sleep or wakeup at various times and may perform (e.g., as needed) random access procedures using the group PDCCH order (e.g., a groupcommon PDCCH order). That is, DRX cycles (or durations included in a DRX cycle, such as DRX “ON” durations) associated each of the first tag 411 or each of the second tags 412 may be aligned such that the first tags 411 or the second tags 412 may transition to an active state over a same duration to perform the requested random access procedure (e.g., requested using the group PDCCH order).

For example, the network entity 405 may use a PDCCH order to request a random access procedure at one or more devices. In some examples, the network entity 405 may transmit the group PDCCH order using DCI (e.g., a DCI format 1_0 with C-RNTI). In such examples, the network entity 405 may use (e.g., define) an RNTI for reading from the first tags 411 or the second tags 412. In some examples, a tag may determine whether a DCI corresponds to a group PDCCH order (or another type of DCI) based on a pattern associated with an FDRA field of the DCI. For example, the tags may determine that the DCI corresponds to a group PDCCH order if bits included in the FDRA field of the DCI are set to “1s”. In some examples, the network entity 405 may use (e.g., define) one or more other FDRA patterns to indicate, to a group of tags (e.g., the first tags 411 or the second tags 412) to perform a random access procedure. In such an example, the DCI may include a quantity of bits (e.g., 6 bits) associated with a random access preamble index field that may be used to indicate a random access preamble to the first tags 411 or the second tags 412. In some examples, the random access preamble index may correspond to a value of 0 (e.g., the bits associated with the random access preamble index field of the DCI may indicate a random access preamble index of 0). In such examples, the first tags 411 or the second tags 412 may be triggered to perform a contention-based random access procedure. Additionally, or alternatively, the tags may refrain from using (e.g., may ignore) one or more other fields included in the DCI.

In some other examples, the random access preamble index may correspond to a value other than 0 (e.g., the bits associated with the random access preamble index field of the DCI may indicate a random access preamble index of 1 or some other value). In such an example, the tags may be triggered to perform a contention-free random access procedure. Additionally, or alternatively, the network entity 405 (e.g., a gNB) may indicate, to the tags, a respective one or more resources for the tags to use for performing the random access procedure. Additionally, or alternatively, the DCI may include a UL/SUL indicator field. In some examples, the network entity 405 may use a quantity of bits (e.g., 1 bit) associated with the UL/SUL field to indicate whether supplementary uplink may be configured for a cell associated with the network entity 405. For example, the tags may be configured with supplementary uplink (e.g., indicated using a supplementaryUplink information element (IE)) in a serving cell (e.g., configured using a ServingCellConfig IE). In such an example, the UL/SUL field may be used to indicate an uplink carrier in the serving cell which may be used to transmit the PRACH.

Additionally or alternatively, the DCI may include a quantity of bits (e.g., 6 bit) associated with an SSB index field. The SSB index field may be used to indicate an SS/PBCH, which may be used to determine a RACH occasion for the PRACH transmission. In some examples, the DCI may include a quantity of bits (e.g., 4 bits) associated with a PRACH mask index field. The PRACH mask index field may indicate a RACH occasion associated with the SS/PBCH indicated using the SS/PBCH index for the PRACH transmission. Additionally, or alternatively, the PRACH Mask index field may be applicable if the preamble index bit is set to a value other than “0” (e.g., a dedicated preamble index assigned by the network to the tags). In some examples, the DCI may include a quantity of reserved bits. The reserved bits may be used to indicate whether the group PDCCH order correspond to a random access procedure for the tags or some other device, and may indicate a tag, a class of tag, or a zone associated with one or more tags. For example, the DCI may indicate a zone 410-a associated with the first tags 411 or a zone 410-b associated with the second tags 412.

In some examples, the reserved bits may be used to indicate time domain resources or frequency domain resources allocated for each time domain resource within a relatively larger time domain resource that may be allocated to the first tags 411 or the second tags 412 or may be allocated to a UE used for helping the first tags 411 or the second tags 412 (e.g., energy harvesting devices). Additionally, or alternatively, the first tags 411 and the second tags 412 may use any combination of the fields included in the DCI for performing the random access procedure (e.g., for RACHing).

In some examples, the first tags 411 and the second tags 412 may transmits a random access message (e.g., a PRACH) using the indicated RACH occasion (e.g., for a contention-free random access procedure) or in a RACH occasion associated with a measured SSB (e.g., for a contention-based random access procedure). Additionally, or alternatively, the first tags 411 and the second tags 412 may monitor the PDCCH. For example, subsequent to the PRACH transmission, the first tags 411 and the second tags 412 may monitor the PDCCH with CRC scrambled with RA-RNTI (DCI format 1_0), which may schedule a random access response PDSCH. In some examples, the random access response may be used to transmit commands to the first tags 411 or the second tags 412. Additionally or alternatively the random access response may be used for continued tag RACHing. For example, the random access response may be used to transmit one or more messages to the first tags 411 or the second tags 412 as part of the random access procedure. In some examples, the random access response may be used or to transmit energy to the first tags 411 or the second tags 412 (e.g., energy harvesting devices) to power up the first tags 411 or the second tags 412, for example subsequent to RACHing (e.g., subsequent to completion of the random access procedure). In some examples, transmitting the group PDCCH order to trigger the random access procedure at the first tags 411 and the second tags 412 may lead to reduced overhead and increased communication reliability within the wireless communication system 400, among other possible benefits.

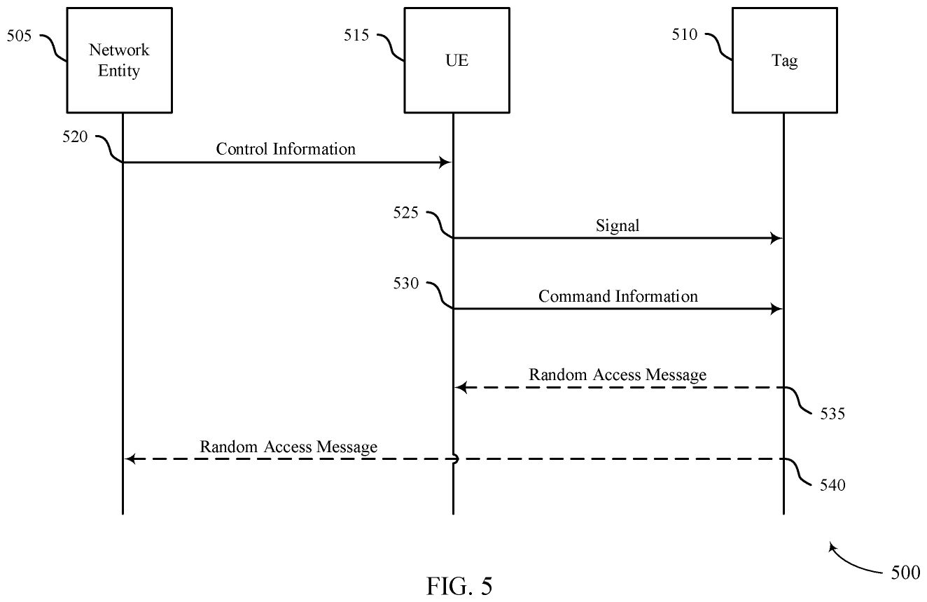

FIG. 5 illustrates an example of a process flow 500 that supports techniques for triggering random access procedures at passive devices in accordance with one or more aspects of the present disclosure. In some examples, the process flow 500 may implement one or more aspects of wireless communication system 100, the wireless communication system 200, the wireless communication system 300, and the wireless communication system 400. For example, the process flow 500 may include example operations associated with a network entity 505 and a UE 515, which may be examples of the corresponding devices described with reference to FIGS. 1 through 4. Additionally, the process flow 500 may include example operations associated with a tag 510 which may be an example of the corresponding device as described with reference to FIGS. 2 and 4. The operations performed by the network entity 505, the UE 515, and the tag 510 may support improvements to communications between the network entity 505 and the tag 510, among other possible benefits.

At 520, the UE 515 may receive control information from the network entity 505. The control information may be an example of control information described throughout the present disclosure including with reference to FIGS. 2 and 3. For example, the control information may indicate a grant of one or more resources and one or more parameters associated with a random access procedure to be performed at the tag 510. In the example of FIG. 2, the tag 510 may be an example of a passive device capable of supporting backscatter communication with the network entity 505 (or the UE 515). In some examples, the control information may correspond to DCI. For example, the control information may include a PDCCH order (or some other type of DCI) as described throughout the present disclosure, including with reference to FIGS. 2 and 3.

At 525, in response to receiving the control information at 520, the UE 515 may transmit a signal to the tag 510 using the one or more resources. The signal may be an example of a continuous wave signal or a modulated signal as described throughout the present disclosure, including with reference to FIGS. 2 and 3. For example, the signal may be used to activate the tag 510.

At 530, the UE 515 may transmit command information to the tag 510 using the one or more resources. The command information may be an example of command information as described throughout the present disclosure including with reference to FIGS. 2 and 3. For example, the command information may indicate, to the tag 510, the one or more parameters for the random access procedure.

In some examples, in response to transmitting the command information at 530, the tag 510 may transmit a random access message (e.g., as part of the indicated random access procedure. For example, at 535, the tag 510 may transmit the random access message to the UE 515 based on the command information. Additionally, or alternatively, at 540, the tag 510 may transmit the random access message to the network entity 505. The random access message may be an example of a random access message as described throughout the present disclosure including with reference to FIGS. 2 through 4. For example, the random access message may include a random access preamble (e.g., may correspond to a PRACH transmission).

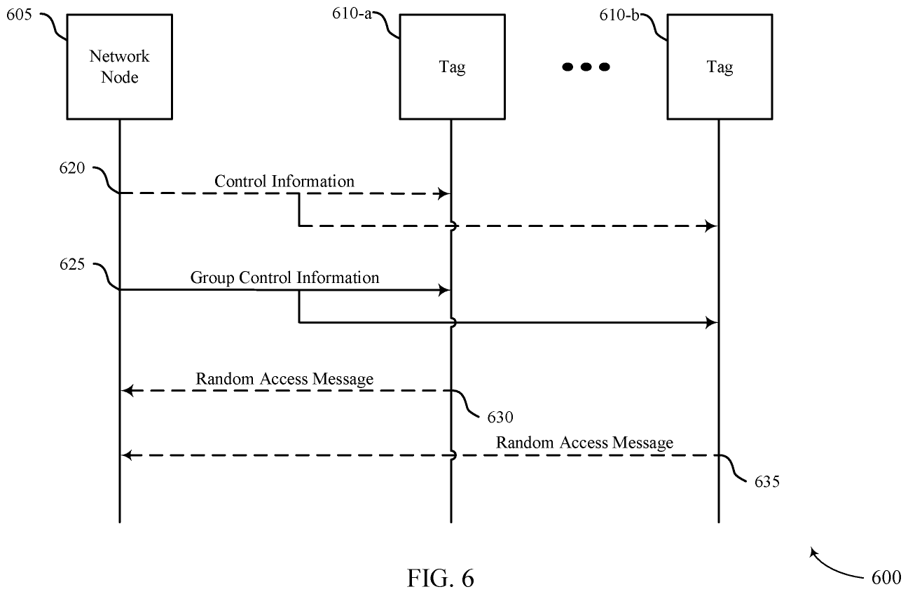

FIG. 6 illustrates an example of a process flow 600 that supports techniques for triggering random access procedures at passive devices in accordance with one or more aspects of the present disclosure. In some examples, the process flow 600 may implement one or more aspects of wireless communication system 100, the wireless communication system 200, the wireless communication system 300, the wireless communication system 400, and the process flow 500. For example, the process flow 600 may include example operations associated with a network entity 605, which may be an example of the corresponding device as described with reference to FIGS. 1 through 5. Additionally, the process flow 600 may include example operations associated with one or more tags 610 (e.g., a tag 610-a and a tag 610-b) which may be an example of the corresponding device as described with reference to FIGS. 2 and 5. The operations performed by the network entity 605 and the tags 610 may support improvements to communications between the network entity 605 and the tags 610, among other possible benefits.

In some examples, the network entity 605 may control information with multiple energy harvesting devices. For example, at 620, the network entity may transmit control information to the tag 610-a and the tag 610-b. The tag 610-a and the tag 610-b may be examples of energy harvesting devices capable of carrier wave generation. In some examples, the control information may be an example of control information described throughout the present disclosure, including with reference to FIGS. 2 and 4. For example, the control information may be used to identify a cycle of active and inactive durations (e.g., a DRX cycle) for the tag 610-a and the tag 610-b.

At 625, during an active duration, the network entity 605 may transmit group control information to the tag 610-a and the tag 610-b. The group control information may be an example of group control information as described throughout the present disclosure, including with reference to FIGS. 2 and 4. For example, the group control information may indicate a request for the tag 610-a and the tag 610-b to perform a random access procedure. Additionally, or alternatively, the group control information may indicate a resource allocation for the tag 610-a and the tag 610-b to perform the random access procedure. In some examples, the group control information may correspond to DCI. For example, the group control information may include a group PDCCH order (or some other type of DCI) as described throughout the present disclosure, including with reference to FIGS. 2 and 4. In some examples, the network entity 605 may use a groupcast mode to transmit the group control information.

In some examples, in response to transmitting the group control information, the tag 610-a or the tag 610-b may transmit a random access message to the network entity 605. For example, at 630 and 635, respectively, the tag 610-a and the tag 610-b may each transmit a random access message to the network entity 605 based on the group control information. The random access message may be an example of a random access message as described throughout the present disclosure including with reference to FIGS. 2 through 4. For example, the random access message may include a random access preamble (e.g., may correspond to a PRACH transmission).

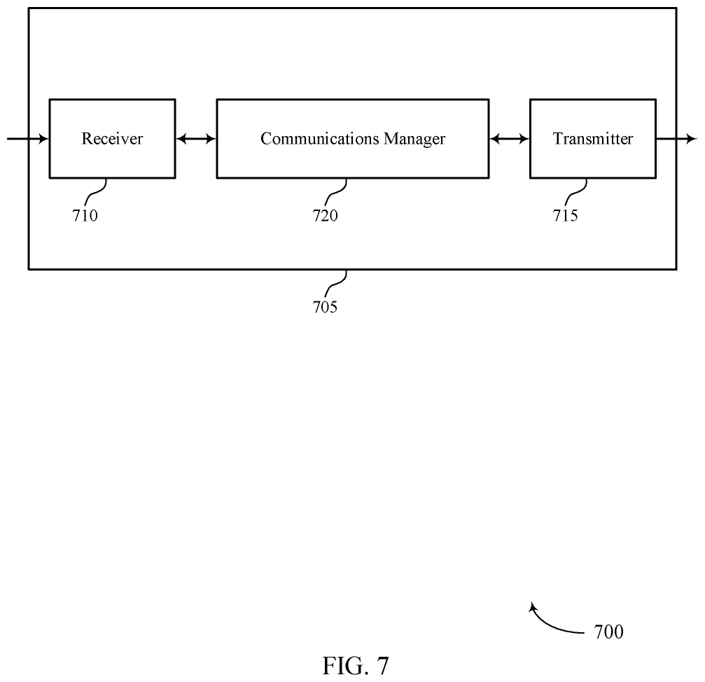

FIG. 7 shows a block diagram 700 of a device 705 that supports techniques for triggering random access procedures at passive devices in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for triggering random access procedures at passive devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for triggering random access procedures at passive devices). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for triggering random access procedures at passive devices as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first network node (e.g., the device 705) in accordance with examples as disclosed herein. For example, the communications manager 720 may be configured as or otherwise support a means for receiving, from a second network node, control information that indicates a grant of one or more resources and one or more parameters associated with a random access procedure to be performed at one or more passive network nodes that support backscatter communication with the first network node. The communications manager 720 may be configured as or otherwise support a means for transmitting, in the one or more resources, a signal to activate the one or more passive network nodes. The communications manager 720 may be configured as or otherwise support a means for transmitting, in the one or more resources, command information to the one or more passive network nodes, the command information indicating the one or more parameters for the random access procedure.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources.

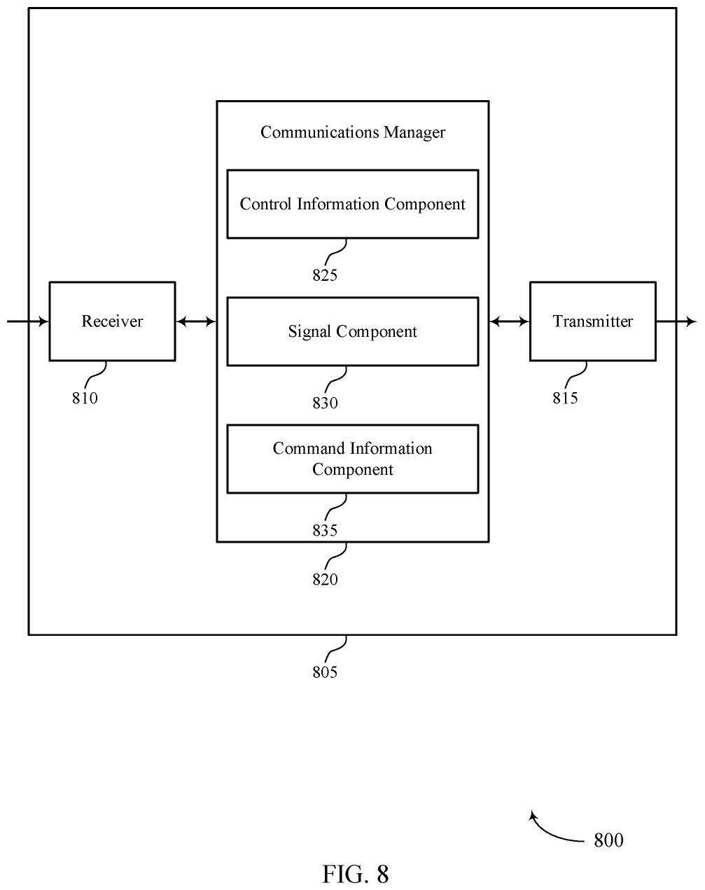

FIG. 8 shows a block diagram 800 of a device 805 that supports techniques for triggering random access procedures at passive devices in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for triggering random access procedures at passive devices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for triggering random access procedures at passive devices). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for triggering random access procedures at passive devices as described herein. For example, the communications manager 820 may include a control information component 825, a signal component 830, a command information component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first network node (e.g., the device 805) in accordance with examples as disclosed herein. The control information component 825 may be configured as or otherwise support a means for receiving, from a second network node, control information that indicates a grant of one or more resources and one or more parameters associated with a random access procedure to be performed at one or more passive network nodes that support backscatter communication with the first network node. The signal component 830 may be configured as or otherwise support a means for transmitting, in the one or more resources, a signal to activate the one or more passive network nodes. The command information component 835 may be configured as or otherwise support a means for transmitting, in the one or more resources, command information to the one or more passive network nodes, the command information indicating the one or more parameters for the random access procedure.

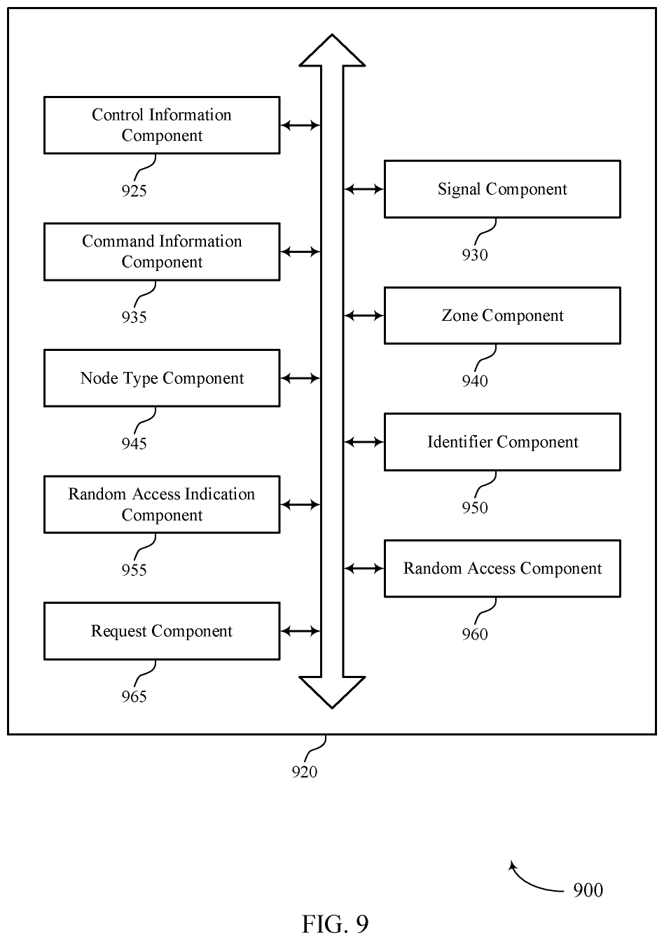

FIG. 9 shows a block diagram 900 of a communications manager 920 that supports techniques for triggering random access procedures at passive devices in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for triggering random access procedures at passive devices as described herein. For example, the communications manager 920 may include a control information component 925, a signal component 930, a command information component 935, a zone component 940, a node type component 945, an identifier component 950, a random access indication component 955, a random access component 960, a request component 965, or any combination thereof. Each of these components may communicate, directly or indirectly, with one another (e.g., via one or more buses).

The communications manager 920 may support wireless communication at a first network node in accordance with examples as disclosed herein. The control information component 925 may be configured as or otherwise support a means for receiving, from a second network node, control information that indicates a grant of one or more resources and one or more parameters associated with a random access procedure to be performed at one or more passive network nodes that support backscatter communication with the first network node. The signal component 930 may be configured as or otherwise support a means for transmitting, in the one or more resources, a signal to activate the one or more passive network nodes. The command information component 935 may be configured as or otherwise support a means for transmitting, in the one or more resources, command information to the one or more passive network nodes, the command information indicating the one or more parameters for the random access procedure.

In some examples, to support transmitting the signal, the zone component 940 may be configured as or otherwise support a means for receiving an indication of a zone identifier associated with the one or more passive network nodes. In some examples, to support transmitting the signal, the signal component 930 may be configured as or otherwise support a means for transmitting the signal in a direction that is based on a geographic location of a zone corresponding to the zone identifier.

In some examples, to support transmitting the signal, the node type component 945 may be configured as or otherwise support a means for receiving an indication of a type of passive network node associated with the one or more passive network nodes. In some examples, to support transmitting the signal, the signal component 930 may be configured as or otherwise support a means for transmitting the signal based on the type of passive network node.

In some examples, to support transmitting the signal, the identifier component 950 may be configured as or otherwise support a means for receiving an indication of one or more identifiers, where each identifier is associated with a respective passive network node of the one or more passive network nodes. In some examples, to support transmitting the signal, the signal component 930 may be configured as or otherwise support a means for transmitting the signal that indicates the one or more identifiers.

In some examples, the control information includes an indication of one or more query parameters associated with a query protocol to be performed at the one or more passive network nodes. In some examples, the command information includes an indication of one or more multi-access protocol parameters to be performed at the one or more passive network nodes.

In some examples, the command information includes an indication of a respective time domain resource allocation for each passive network node of the one or more passive network nodes to perform the random access procedure. In some examples, the signal includes a continuous wave signal.

In some examples, to support transmitting the signal, the random access indication component 955 may be configured as or otherwise support a means for receiving an indication that the random access procedure is to be performed at the one or more passive network nodes. In some examples, to support transmitting the signal, the signal component 930 may be configured as or otherwise support a means for transmitting the signal based on the indication that the random access procedure is to be performed at the one or more passive network nodes.

In some examples, the control information includes an indication of an RNTI that indicates that the control information includes the one or more parameters associated with the random access procedure to be performed at the one or more passive network nodes. In some examples, the control information includes a bit pattern in a FDRA field. In some examples, the bit pattern indicates that the control information includes the one or more parameters associated with the random access procedure to be performed at the one or more passive network nodes.

In some examples, the control information includes one or more bits that indicate that the control information includes the one or more parameters associated with the random access procedure to be performed at the one or more passive network nodes. In some examples, the random access component 960 may be configured as or otherwise support a means for receiving, based on the command information, a random access message from at least one passive network node of the one or more passive network nodes.

In some examples, the request component 965 may be configured as or otherwise support a means for receiving a PDCCH order that indicates the grant of one or more resources and the one or more parameters associated with the random access procedure to be performed at the one or more passive network nodes.

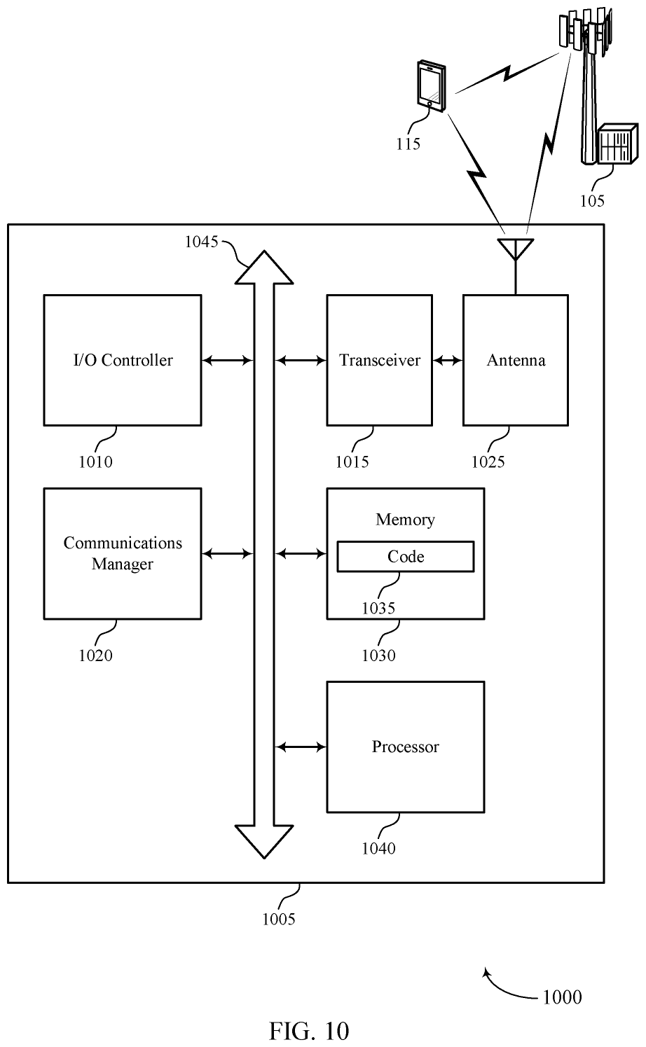

FIG. 10 shows a diagram of a system 1000 including a device 1005 that supports techniques for triggering random access procedures at passive devices in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system.

Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for triggering random access procedures at passive devices). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first network node (e.g., the device 1005) in accordance with examples as disclosed herein. For example, the communications manager 1020 may be configured as or otherwise support a means for receiving, from a second network node, control information that indicates a grant of one or more resources and one or more parameters associated with a random access procedure to be performed at one or more passive network nodes that support backscatter communication with the first network node. The communications manager 1020 may be configured as or otherwise support a means for transmitting, in the one or more resources, a signal to activate the one or more passive network nodes. The communications manager 1020 may be configured as or otherwise support a means for transmitting, in the one or more resources, command information to the one or more passive network nodes, the command information indicating the one or more parameters for the random access procedure.

By including or configuring the communications manager 1020 in accordance with examples as described herein, the device 1005 may support techniques for improved communication reliability and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for triggering random access procedures at passive devices as described herein, or the processor 1040 and the memory 1030 may be otherwise configured to perform or support such operations.

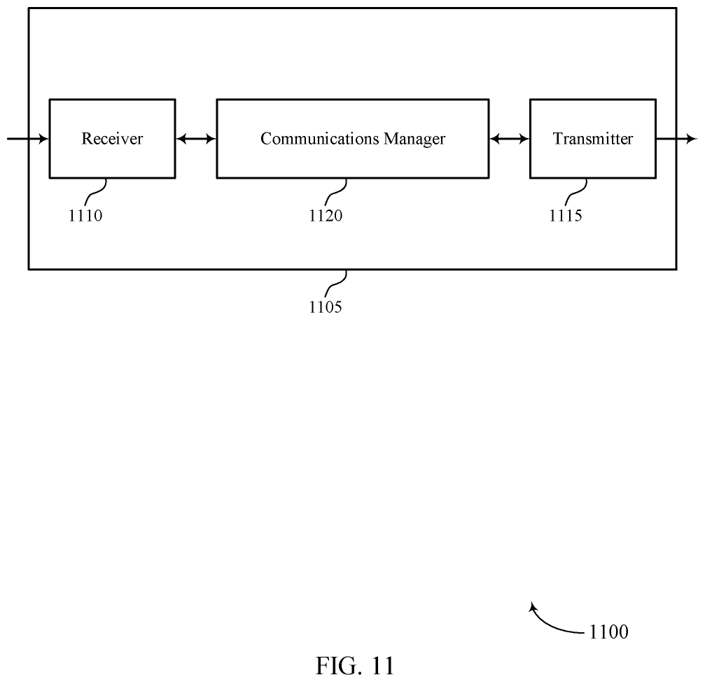

FIG. 11 shows a block diagram 1100 of a device 1105 that supports techniques for triggering random access procedures at passive devices in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas.

Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for triggering random access procedures at passive devices as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network node (e.g., the device 1105) in accordance with examples as disclosed herein. For example, the communications manager 1120 may be configured as or otherwise support a means for communicating, with a set of multiple energy harvesting network nodes, control information to identify a cycle of active and inactive durations for the set of multiple energy harvesting network nodes that are capable of carrier wave generation. The communications manager 1120 may be configured as or otherwise support a means for transmitting, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources.

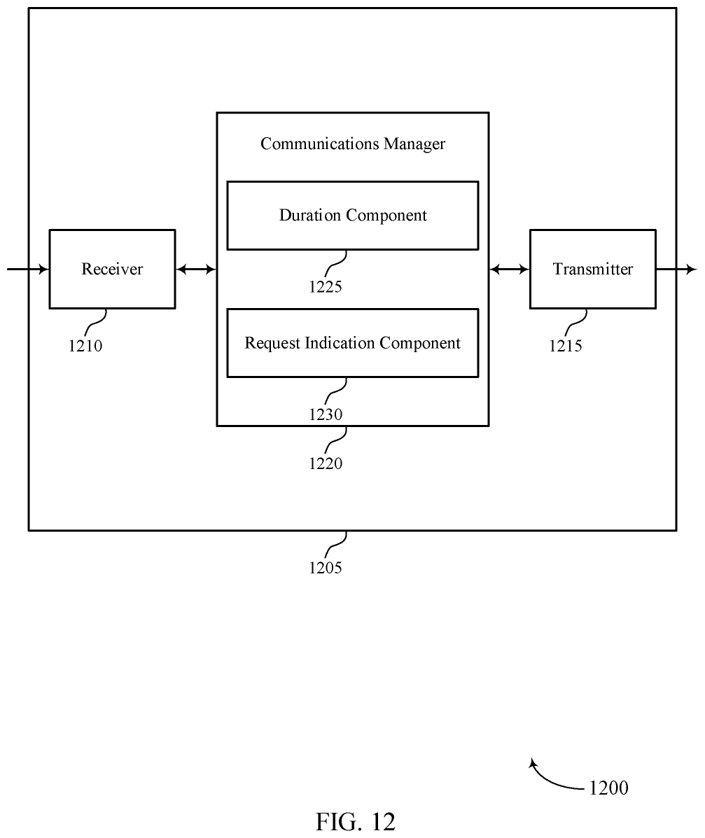

FIG. 12 shows a block diagram 1200 of a device 1205 that supports techniques for triggering random access procedures at passive devices in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for triggering random access procedures at passive devices as described herein. For example, the communications manager 1220 may include a duration component 1225 a request indication component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network node (e.g., the device 1205) in accordance with examples as disclosed herein. The duration component 1225 may be configured as or otherwise support a means for communicating, with a set of multiple energy harvesting network nodes, control information to identify a cycle of active and inactive durations for the set of multiple energy harvesting network nodes that are capable of carrier wave generation. The request indication component 1230 may be configured as or otherwise support a means for transmitting, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure.

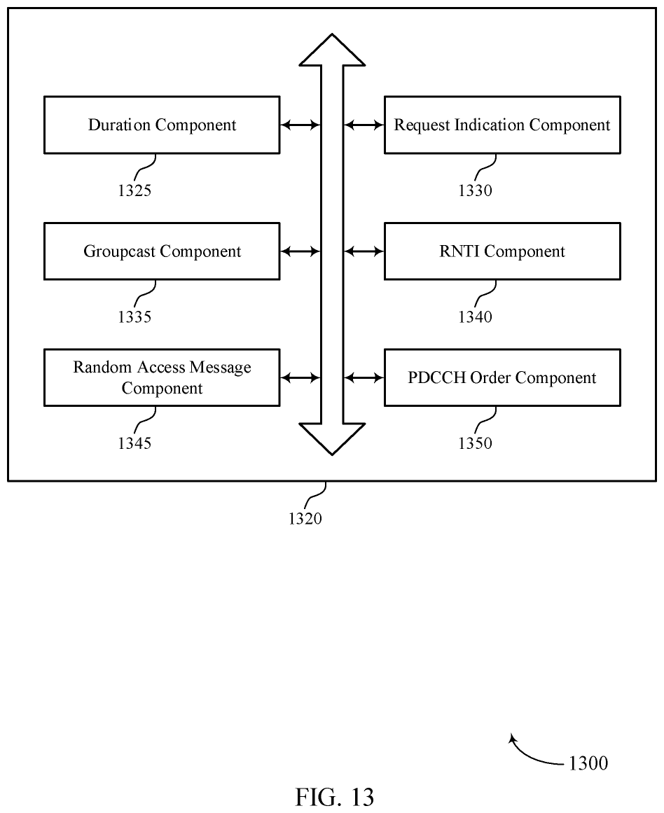

FIG. 13 shows a block diagram 1300 of a communications manager 1320 that supports techniques for triggering random access procedures at passive devices in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for triggering random access procedures at passive devices as described herein. For example, the communications manager 1320 may include a duration component 1325, a request indication component 1330, a groupcast component 1335, an RNTI component 1340, a random access message component 1345, a PDCCH order component 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network node in accordance with examples as disclosed herein. The duration component 1325 may be configured as or otherwise support a means for communicating, with a set of multiple energy harvesting network nodes, control information to identify a cycle of active and inactive durations for the set of multiple energy harvesting network nodes that are capable of carrier wave generation. The request indication component 1330 may be configured as or otherwise support a means for transmitting, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure.

In some examples, the groupcast component 1335 may be configured as or otherwise support a means for transmitting the group control information using a groupcast mode. In some examples, the group control information includes an indication of an RNTI that indicates the request for the set of multiple energy harvesting network nodes to perform the random access procedure.

In some examples, the group control information includes a bit pattern in a FDRA field. In some examples, the group control information includes a random access preamble index that indicates a type of random access procedure to be performed at the set of multiple energy harvesting network nodes. In some examples, the group control information includes one or more bits that indicate the request for the set of multiple energy harvesting network nodes to perform the random access procedure.

In some examples, the random access message component 1345 may be configured as or otherwise support a means for receiving, during the active duration and based on the group control information, at least one random access messages from one or more energy harvesting network nodes of the set of multiple energy harvesting network nodes. In some examples, the PDCCH order component 1350 may be configured as or otherwise support a means for transmitting a PDCCH order that indicates the request for the set of multiple energy harvesting network nodes to perform the random access procedure and the resource allocation for the set of multiple energy harvesting network nodes to perform the random access procedure.

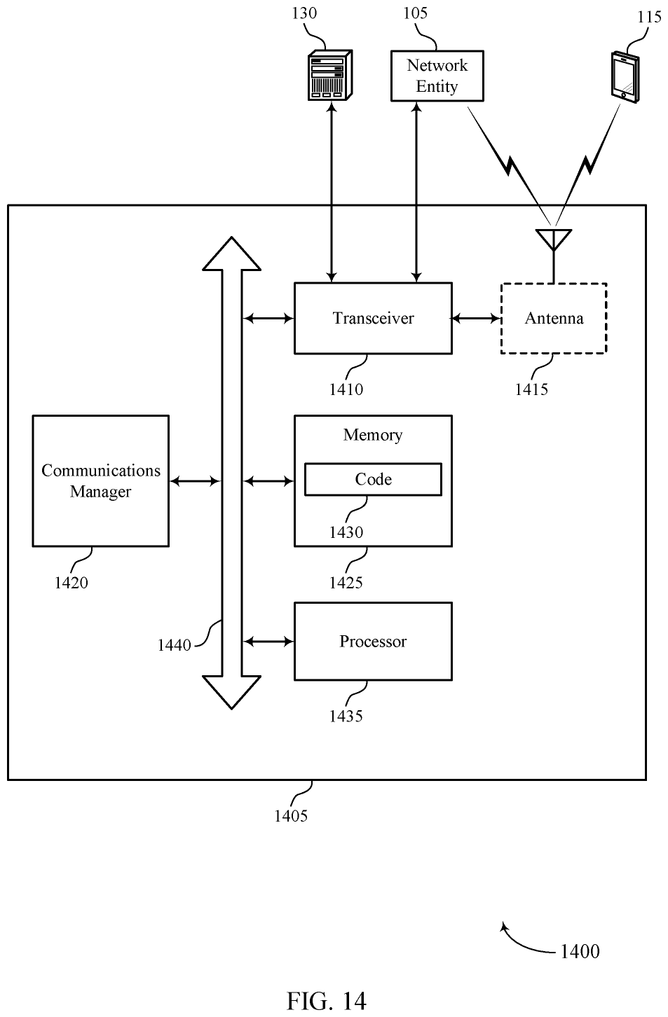

FIG. 14 shows a diagram of a system 1400 including a device 1405 that supports techniques for triggering random access procedures at passive devices in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for triggering random access procedures at passive devices). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communication network technology to provide communication between network entities 105.

The communications manager 1420 may support wireless communication at a network node (e.g., the device 1405) in accordance with examples as disclosed herein. For example, the communications manager 1420 may be configured as or otherwise support a means for communicating, with a set of multiple energy harvesting network nodes, control information to identify a cycle of active and inactive durations for the set of multiple energy harvesting network nodes that are capable of carrier wave generation. The communications manager 1420 may be configured as or otherwise support a means for transmitting, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure.

By including or configuring the communications manager 1420 in accordance with examples as described herein, the device 1405 may support techniques for improved communication reliability and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of techniques for triggering random access procedures at passive devices as described herein, or the processor 1435 and the memory 1425 may be otherwise configured to perform or support such operations.

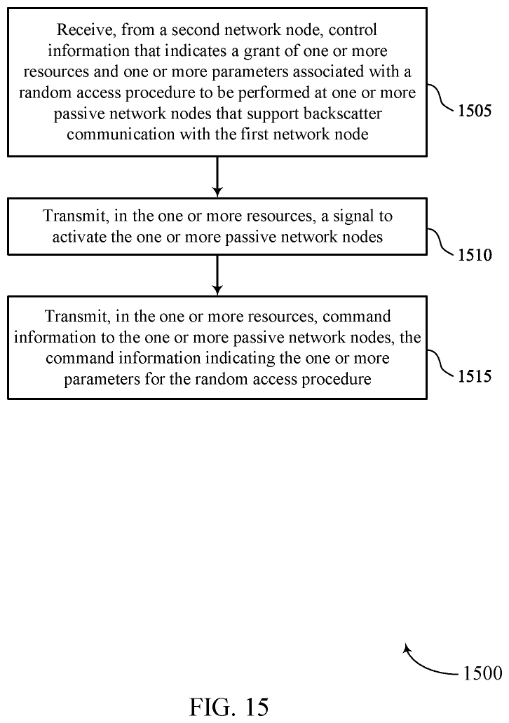

FIG. 15 shows a flowchart illustrating a method 1500 that supports techniques for triggering random access procedures at passive devices in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a second network node, control information that indicates a grant of one or more resources and one or more parameters associated with a random access procedure to be performed at one or more passive network nodes that support backscatter communication with the first network node. The operations of 1505 may be performed in accordance with examples as disclosed herein. In some examples, aspects of the operations of 1505 may be performed by a control information component 925 as described with reference to FIG. 9.

At 1510, the method may include transmitting, in the one or more resources, a signal to activate the one or more passive network nodes. The operations of 1510 may be performed in accordance with examples as disclosed herein. In some examples, aspects of the operations of 1510 may be performed by a signal component 930 as described with reference to FIG. 9.

At 1515, the method may include transmitting, in the one or more resources, command information to the one or more passive network nodes, the command information indicating the one or more parameters for the random access procedure.

The operations of 1515 may be performed in accordance with examples as disclosed herein. In some examples, aspects of the operations of 1515 may be performed by a command information component 935 as described with reference to FIG. 9.

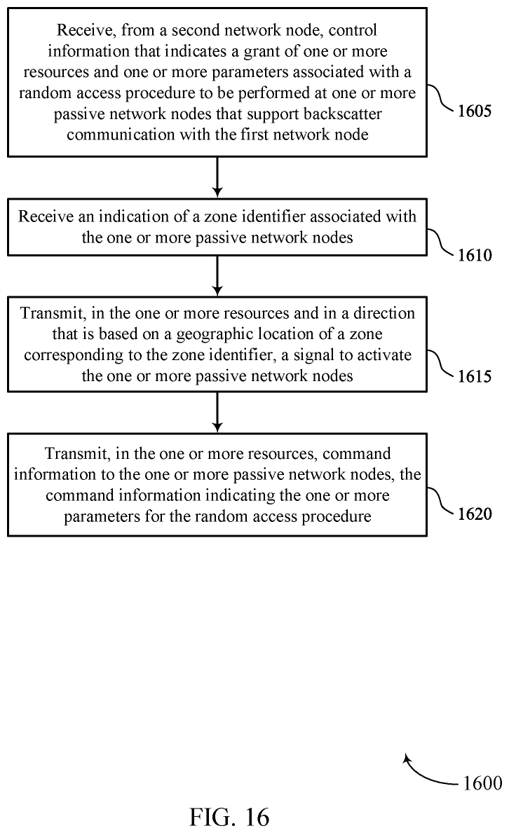

FIG. 16 shows a flowchart illustrating a method 1600 that supports techniques for triggering random access procedures at passive devices in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a second network node, control information that indicates a grant of one or more resources and one or more parameters associated with a random access procedure to be performed at one or more passive network nodes that support backscatter communication with the first network node. The operations of 1605 may be performed in accordance with examples as disclosed herein. In some examples, aspects of the operations of 1605 may be performed by a control information component 925 as described with reference to FIG. 9.

At 1610, the method may include receiving an indication of a zone identifier associated with the one or more passive network nodes. The operations of 1610 may be performed in accordance with examples as disclosed herein. In some examples, aspects of the operations of 1610 may be performed by a zone component 940 as described with reference to FIG. 9.

At 1615, the method may include transmitting, in the one or more resources and in a direction that is based on a geographic location of a zone corresponding to the zone identifier, a signal to activate the one or more passive network nodes. The operations of 1615 may be performed in accordance with examples as disclosed herein. In some examples, aspects of the operations of 1615 may be performed by a signal component 930 as described with reference to FIG. 9.

At 1620, the method may include transmitting, in the one or more resources, command information to the one or more passive network nodes, the command information indicating the one or more parameters for the random access procedure. The operations of 1620 may be performed in accordance with examples as disclosed herein. In some examples, aspects of the operations of 1620 may be performed by a command information component 935 as described with reference to FIG. 9.

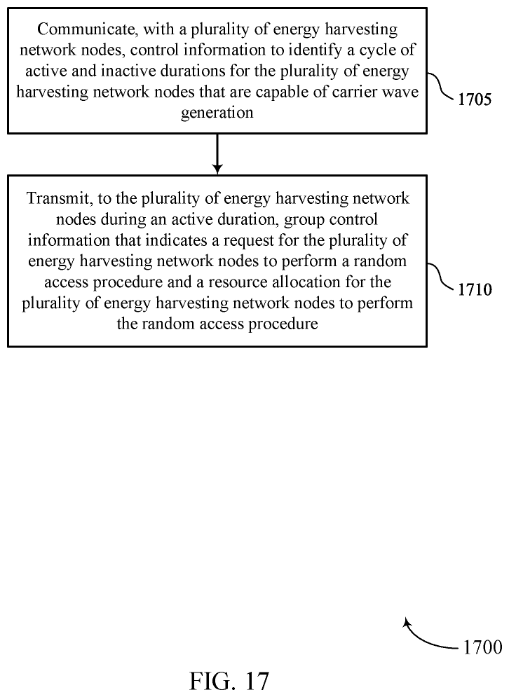

FIG. 17 shows a flowchart illustrating a method 1700 that supports techniques for triggering random access procedures at passive devices in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include communicating, with a set of multiple energy harvesting network nodes, control information to identify a cycle of active and inactive durations for the set of multiple energy harvesting network nodes that are capable of carrier wave generation. The operations of 1705 may be performed in accordance with examples as disclosed herein. In some examples, aspects of the operations of 1705 may be performed by a duration component 1325 as described with reference to FIG. 13.

At 1710, the method may include transmitting, to the set of multiple energy harvesting network nodes during an active duration, group control information that indicates a request for the set of multiple energy harvesting network nodes to perform a random access procedure and a resource allocation for the set of multiple energy harvesting network nodes to perform the random access procedure. The operations of 1710 may be performed in accordance with examples as disclosed herein. In some examples, aspects of the operations of 1710 may be performed by a request indication component 1330 as described with reference to FIG. 13.

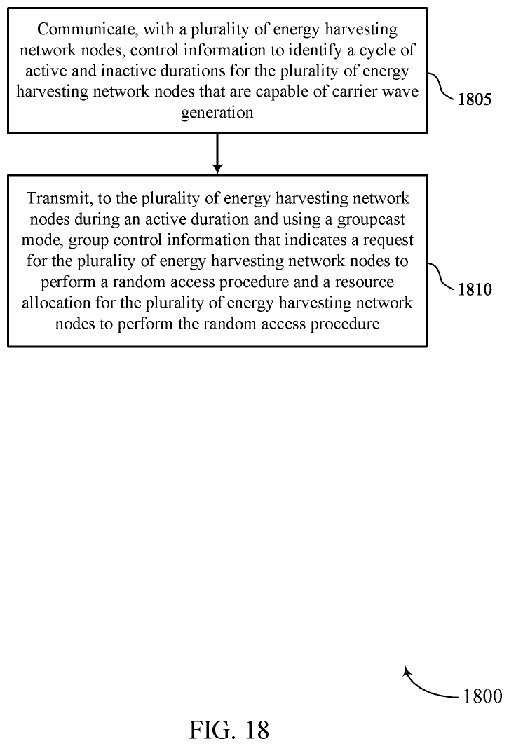

FIG. 18 shows a flowchart illustrating a method 1800 that supports techniques for triggering random access procedures at passive devices in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include communicating, with a set of multiple energy harvesting network nodes, control information to identify a cycle of active and inactive durations for the set of multiple energy harvesting network nodes that are capable of carrier wave generation. The operations of 1805 may be performed in accordance with examples as disclosed herein. In some examples, aspects of the operations of 1805 may be performed by a duration component 1325 as described with reference to FIG. 13.

At 1810, the method may include transmitting, to the set of multiple energy harvesting network nodes during an active duration and using a groupcast mode, group control information that indicates a request for the set of multiple energy harvesting network nodes to perform a random access procedure and a resource allocation for the set of multiple energy harvesting network nodes to perform the random access procedure. The operations of 1810 may be performed in accordance with examples as disclosed herein. In some examples, aspects of the operations of 1810 may be performed by a request indication component 1330 as described with reference to FIG. 13.

The following provides an overview of aspects of the present disclosure:

Aspect 1: A method for wireless communication at a first network node, comprising: receiving, from a second network node, control information that indicates a grant of one or more resources and one or more parameters associated with a random access procedure to be performed at one or more passive network nodes that support backscatter communication with the first network node; transmitting, in the one or more resources, a signal to activate the one or more passive network nodes; and transmitting, in the one or more resources, command information to the one or more passive network nodes, the command information indicating the one or more parameters for the random access procedure.

Aspect 2: The method of aspect 1, further comprising: receiving an indication of a zone identifier associated with the one or more passive network nodes; and transmitting the signal in a direction that is based on a geographic location of a zone corresponding to the zone identifier.

Aspect 3: The method of aspect 1, further comprising: receiving an indication of a type of passive network node associated with the one or more passive network nodes; and transmitting the signal based on the type of passive network node.

Aspect 4: The method of aspect 1, further comprising: receiving an indication of one or more identifiers, wherein each identifier is associated with a respective passive network node of the one or more passive network nodes; and transmitting the signal that indicates the one or more identifiers.

Aspect 5: The method of any of aspects 1 through 4, wherein the control information comprises an indication of one or more query parameters associated with a Q protocol to be performed at the one or more passive network nodes.

Aspect 6: The method of any of aspects 1 through 5, wherein the command information comprises an indication of one or more multi-access protocol parameters to be performed at the one or more passive network nodes.

Aspect 7: The method of any of aspects 1 through 6, wherein the command information comprises an indication of a respective time domain resource allocation for each passive network node of the one or more passive network nodes to perform the random access procedure.

Aspect 8: The method of any of aspects 1 through 7, wherein the signal comprises a continuous wave signal.

Aspect 9: The method of any of aspects 1 through 8, further comprising: receiving an indication that the random access procedure is to be performed at the one or more passive network nodes; and transmitting the signal based on the indication that the random access procedure is to be performed at the one or more passive network nodes.

Aspect 10: The method of any of aspects 1 through 9, wherein the control information comprises an indication of an RNTI that indicates that the control information includes the one or more parameters associated with the random access procedure to be performed at the one or more passive network nodes.

Aspect 11: The method of any of aspects 1 through 9, wherein the control information comprises a bit pattern in a FDRA field, and the bit pattern indicates that the control information includes the one or more parameters associated with the random access procedure to be performed at the one or more passive network nodes.

Aspect 12: The method of any of aspects 1 through 9, wherein the control information comprises one or more bits that indicate that the control information includes the one or more parameters associated with the random access procedure to be performed at the one or more passive network nodes.

Aspect 13: The method of any of aspects 1 through 12, further comprising: receiving, based on the command information, a random access message from at least one passive network node of the one or more passive network nodes.

Aspect 14: The method of any of aspects 1 through 13, further comprising: receiving a PDCCH order that indicates the grant of one or more resources and the one or more parameters associated with the random access procedure to be performed at the one or more passive network nodes.

Aspect 15: A method for wireless communication at a network node, comprising: communicating, with a plurality of energy harvesting network nodes, control information to identify a cycle of active and inactive durations for the plurality of energy harvesting network nodes that are capable of carrier wave generation; and transmitting, to the plurality of energy harvesting network nodes during an active duration, group control information that indicates a request for the plurality of energy harvesting network nodes to perform a random access procedure and a resource allocation for the plurality of energy harvesting network nodes to perform the random access procedure.

Aspect 16: The method of aspect 15, further comprising: transmitting the group control information using a groupcast mode.

Aspect 17: The method of any of aspects 15 through 16, wherein the group control information comprises an indication of an RNTI that indicates the request for the plurality of energy harvesting network nodes to perform the random access procedure.

Aspect 18: The method of any of aspects 15 through 16, wherein the group control information comprises a bit pattern in an FDRA field.

Aspect 19: The method of any of aspects 15 through 16, wherein the group control information comprises a random access preamble index that indicates a type of random access procedure to be performed at the plurality of energy harvesting network nodes.

Aspect 20: The method of any of aspects 15 through 16, wherein the group control information comprises one or more bits that indicate the request for the plurality of energy harvesting network nodes to perform the random access procedure.

Aspect 21: The method of any of aspects 15 through 20, further comprising: receiving, during the active duration and based on the group control information, at least one random access messages from one or more energy harvesting network nodes of the plurality of energy harvesting network nodes.

Aspect 22: The method of any of aspects 15 through 21, further comprising: transmitting a PDCCH order that indicates the request for the plurality of energy harvesting network nodes to perform the random access procedure and the resource allocation for the plurality of energy harvesting network nodes to perform the random access procedure.

Aspect 23: A first network node for wireless communication, comprising a memory; and at least one processor coupled to the memory, wherein the at least one processor is configured to perform a method of any of aspects 1 through 14.

Aspect 24: An apparatus for wireless communication at a first network node, comprising at least one means for performing a method of any of aspects 1 through 14.

Aspect 25: A non-transitory computer-readable medium having code for wireless communication stored thereon that, when executed by a first network node, causes the network node to perform a method of any of aspects 1 through 14.

Aspect 26: A network node for wireless communication, comprising a memory; and at least one processor coupled to the memory, wherein the at least one processor is configured to perform a method of any of aspects 15 through 22.

Aspect 27: An apparatus for wireless communication at a network node, comprising at least one means for performing a method of any of aspects 15 through 22.

Aspect 28: A non-transitory computer-readable medium having code for wireless communication stored thereon that, when executed by a network node, causes the network node to perform a method of any of aspects 15 through 22.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium.

Other aspects and implementations are within the scope of the disclosure and claims.

For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network node for wireless communication, comprising:
a memory; and
at least one processor coupled to the memory, wherein the at least one processor is configured to:
receive, from a second network node, control information that indicates a grant of one or more resources and one or more parameters associated with a random access procedure to be performed at one or more passive network nodes that support backscatter communication with the first network node;
transmit, in the one or more resources, a signal to activate the one or more passive network nodes; and
transmit, in the one or more resources, command information to the one or more passive network nodes, the command information indicating the one or more parameters for the random access procedure.

2. The first network node of claim 1, wherein the at least one processor is configured to receive an indication of a zone identifier associated with the one or more passive network nodes, and wherein, to transmit the signal, the at least one processor is configured to transmit the signal in a direction that is based on a geographic location of a zone corresponding to the zone identifier.

3. The first network node of claim 1, wherein the at least one processor is configured to receive an indication of a type of passive network node associated with the one or more passive network nodes, and wherein, to transmit the signal, the at least one processor is configured to transmit the signal based on the type of passive network node.

4. The first network node of claim 1, wherein the at least one processor is configured to receive an indication of one or more identifiers, each identifier is associated with a respective passive network node of the one or more passive network nodes, and wherein, to transmit the signal, the at least one processor is configured to transmit the signal that indicates the one or more identifiers.

5. The first network node of claim 1, wherein the control information comprises an indication of one or more query parameters associated with a query protocol to be performed at the one or more passive network nodes.

6. The first network node of claim 1, wherein the command information comprises an indication of one or more multi-access protocol parameters to be performed at the one or more passive network nodes.

7. The first network node of claim 1, wherein the command information comprises an indication of a respective time domain resource allocation for each passive network node of the one or more passive network nodes to perform the random access procedure.

8. The first network node of claim 1, wherein the signal comprises a continuous wave signal.

9. The first network node of claim 1, wherein the at least one processor is configured to receive an indication that the random access procedure is to be performed at the one or more passive network nodes, and wherein, to transmit the signal, the at least one processor is configured to transmit the signal based on the indication that the random access procedure is to be performed at the one or more passive network nodes.

10. The first network node of claim 1, wherein the control information comprises an indication of a radio network temporary identifier that indicates that the control information includes the one or more parameters associated with the random access procedure to be performed at the one or more passive network nodes.

11. The first network node of claim 1, wherein the control information comprises a bit pattern in a frequency domain resource assignment field, and wherein the bit pattern indicates that the control information includes the one or more parameters associated with the random access procedure to be performed at the one or more passive network nodes.

12. The first network node of claim 1, wherein the control information comprises one or more bits that indicate that the control information includes the one or more parameters associated with the random access procedure to be performed at the one or more passive network nodes.

13. The first network node of claim 1, wherein the at least one processor is configured to receive, based on the command information, a random access message from at least one passive network node of the one or more passive network nodes.

14. The first network node of claim 1, wherein the at least one processor is configured to receive a physical downlink control channel order that indicates the grant of one or more resources and the one or more parameters associated with the random access procedure to be performed at the one or more passive network nodes.

15. A network node for wireless communication, comprising:
a memory; and
at least one processor coupled to the memory, wherein the at least one processor is configured to:
communicate, with a plurality of energy harvesting network nodes, control information to identify a cycle of active and inactive durations for the plurality of energy harvesting network nodes that are capable of carrier wave generation; and
transmit, to the plurality of energy harvesting network nodes during an active duration, group control information that indicates a request for the plurality of energy harvesting network nodes to perform a random access procedure and a resource allocation for the plurality of energy harvesting network nodes to perform the random access procedure.

16. The network node of claim 15, wherein the at least one processor is configured to transmit the group control information using a groupcast mode.

17. The network node of claim 15, wherein the group control information comprises an indication of a radio network temporary identifier that indicates the request for the plurality of energy harvesting network nodes to perform the random access procedure.

18. The network node of claim 15, wherein the group control information comprises a bit pattern in a frequency domain resource assignment field.

19. The network node of claim 15, wherein the group control information comprises a random access preamble index that indicates a type of random access procedure to be performed at the plurality of energy harvesting network nodes.

20. The network node of claim 15, wherein the group control information comprises one or more bits that indicate the request for the plurality of energy harvesting network nodes to perform the random access procedure.

21-30. (canceled)
